(19) United States
(12) Patent Application Publication
(10) Pub. No.: US 2024/0182674 A1
(43) Pub. Date: Jun. 6, 2024

(54) USE OF A STABILIZER COMPOSITION FOR STABILIZING HALOGEN-FREE RECYCLED THERMOPLASTICS, STABILIZER COMPOSITION, MASTER BATCH OR CONCENTRATE, STABILIZED PLASTIC COMPOSITION, PROCESS FOR STABILIZING HALOGEN-FREE RECYCLED THERMOPLASTICS, AND USE OF COMPOSITIONS

(71) Applicant: FRAUNHOFER-GESELLSCHAFT ZUR FÖRDERUNG DER ANGEWANDTEN FORSCHUNG E.V., München (DE)

(72) Inventors: Rudolf PFAENDNER, Darmstadt (DE); Matthias POLIDAR, Darmstadt (DE); Elke METSCH-ZILLIGEN, Darmstadt (DE)

(73) Assignee: FRAUNHOFER-GESELLSCHAFT ZUR FÖRDERUNG DER ANGEWANDTEN FORSCHUNG E.V., München (DE)

(21) Appl. No.: 18/548,518

(22) PCT Filed: Feb. 25, 2022
(86) PCT No.: PCT/EP2022/054870

§ 371 Date: Aug. 31, 2023

(30) Foreign Application Priority Data
Mar. 4, 2021 (DE) 10 2021 202 103.4

(51) Int. Cl. C08K 3/30; C08K 5/098; C08K 5/134; C08K 5/1545

(52) U.S. Cl. CPC C08K 3/30; C08K 5/098; C08K 5/1345; C08K 5/1545; C08K 2201/012

(57) ABSTRACT

The invention relates to a new type of stabilizer composition for stabilizing halogen-free recycled thermoplastics. In addition, the present invention relates to a stabilizer composition, a master batch or concentrate, a stabilized plastic composition, a process for stabilizing halogen-free recycled thermoplastics and to possible uses of the composition.

The present invention relates to an innovative stabilizer composition for stabilizing halogen-free thermoplastic plastic recyclates. In addition, the present invention relates to a stabilizer composition, a master batch or a concentrate, a stabilized plastic composition, a method of stabilizing halogen-free thermoplastic plastic recyclates, and to possible uses of the composition.

Plastic recyclates are a growing market and an important element in recycling management of natural resources, with recyclates ideally being intended to replace new plastics having an identical or at least comparable property profile. Recyclates from the production of plastic parts (so-called “postindustrial” recyclates) and from collections of old plastics (so-called “post-consumer recyclates), however, differ chemically from new plastic products. Irreversible changes in the polymer chains result during the first processing steps (e.g. by compounding, extrusion, or injection molding) and during use frequently over many years and in demanding areas of application (e.g. high temperatures and/or UV light) due to mechano-chemical, chemical, or light-induced processes (see e.g. R. Pfaendner et al., Anew. Makromol. Chemie 1995, 232, 193-227, R. Pfaendner, Kunststoffe International 12/2015, 41-44, J. Pospisil et al., Pol. Degr. Stab. 1995, 48, 351-358, F. P. La Mantia, Macromol. Symp. 1998, 135, 157-165,).

New chemical groups are produced in the polymer chain and/or the composition of the polymers is changed on the molecular level by radical reactions in the presence of oxygen. The chemical changes produced by the damage process and by the aging process are above all hydroperoxide groups, aliphatic carbonyl groups, alpha-beta unsaturated carbonyl groups, alcohol groups, acid groups, ester groups, and peroxy acid groups, i.e. structures that, for example, are typically not present in new polyolefin products and are above all produced as a consequence of oxidation processes (J. Pospisil et al. Macromol. Symp. 1998, 135, 247-263). Furthermore, recyclates in particular comprise polyolefins, frequently unsaturated structures, i.e. vinylide groups, vinylene groups, and vinyl groups, wherein vinylene groups can even be present in conjugated form. Unsaturated structures are produced here by chain splitting reactions and disproportionation reactions (H. Hjnske et al., Pol. Degr. Stab. 1991, 34, 279-293,). The concentration of these newly formed groups increases with the processing intensity (process management, shear, temperature), the area of use (UV light, high temperatures, contact media), and the time of use. Furthermore, the formation of these structures in oxidation processes and consecutive reactions can be catalyzed by metals and by pigments. The structural inhomogeneities of a recyclate consequently influence the plastic properties such as the mechanical properties or the morphology. Recyclates or predamaged plastics are more sensitive to oxidation than as new material due to the newly formed chemical structures since they act as initiator sites for a further oxidation or as prodegrants (A. S. Maxwell, Pol. Eng. Sci. 2008, 48, 381-385, I. H. Craig, J. R. White, J. Mater. Sci. 2006, 41, 993-1006, S. Luzuriaga et al. Pol. Degr. Stab. 2006, 91, 1226-1232). It is furthermore documented that the degradation rate depends on the concentration of the chromophoric “contaminants” (M. S. Rabello, J. R. White, Polym. Degrad. Stab. 1997, 56, 55-73). The concentrations of the described “aging” structures in the recyclates can increase by several orders of magnitude with respect to the new material. It is furthermore known that even small portions of old plastics in mixtures with new products result in a disproportional property degradation (V. S. Cecon et al., Polym. Degr. Stab. 2021, 190. 109627).

Post-stabilization with selected stabilizers such as antioxidants is an important method to achieve a quality improvement of plastic recyclates. The stabilizers used protect the recyclate from further oxidative (or photo-oxidative) damage or at least delay it. Since new plastic products and plastic recyclates, as described, differ significantly chemically and since recyclates are more oxidation sensitive due to this predamage and imitator sites, it is a challenging object to develop powerful stabilizers for an efficient stabilization of plastic recyclates that is distinguished from the new product due to the described structural differences of the recyclate.

Due to the differences now recognized between new plastic products and plastic recyclates, special recyclate stabilizer compositions have become known and are also available as commercial products (e.g. the Recyclobyk products of BYK Chemie GmbH, Wesel). Known technical stabilization solutions that take account of the demands of recyclates are, for example: described in the following patents/patent applications, for example:
stabilization composition consisting of a phenolic antioxidant, a phosphite, and a fatty acid salt (EP 0662101).

Stabilization composition consisting of a phenolic antioxidant, a phosphite, and a metal oxide such as calcium oxide (U.S. Pat. Nos. 6,525,158, 6,251,972).

Stabilization composition consisting of a phenolic antioxidant and a polyfunctional epoxide (EP 0702704).

Stabilization by a macrocyclic piperidine (U.S. Pat. No. 5,789,470).

Stabilization composition consisting of a secondary aromatic amine and a polyfunctional epoxide (WO 97/30112).

Discoloration of damaged polyolefins by a hydroxylamine (EP 0470048).

Mixture of antioxidants, mold lubricants, anti-blocking agents, UV stabilizers, and antistatic agents for recyclate films (DD 288161).

Stabilization composition for mixed plastics consisting of a phenolic antioxidant and a phosphite/phosphonite (EP 0506614).

The following applications of the applicant for the stabilization of recyclates are furthermore present:
WO 2019063550: Stabilization composition comprising alditols or cyclitols
WO 2020152337: Stabilization composition comprising compounds that can react with carbonyl groups and primary and/or secondary antioxidants
WO 2020193563: Stabilization compositions comprising substituted sugar molecules

Inorganic sulfites have e.g. been proposed in the form of calcium sulfite or lead sulfite as stabilizers for polymers comprising halogens such as PVC (e.g. EP 313113, U.S. Pat. No. 3,542,725, US20030104954) and for polyvinylpyrrolidone (U.S. Pat. No. 2,872,433, DE102005005974), but have not yet been described for the thermal stabilization of plastic recyclates. Organic esters of sulfurous acid are generally known for the stabilization of polymers (e.g. DD 247913, U.S. Pat. No. 3,542,725), but not for the stabilization of plastic recyclates.

Despite the known solutions for the post-stabilization of recyclates, there is still a demand for particularly high performance, environmentally friendly, and inexpensive stabilizer compositions for recyclates that are obtained from the compositions in accordance with the invention of inorganic sulfites and primary antioxidants.

This object is satisfied by the features of the independent claims. The dependent claims in this respect set forth advantageous further developments.

The invention thus relates in a first aspect to the use of at least one stabilizer composition comprising or consisting of
at least one sulfite and/or at least one thiosulfate in combination with at least one primary antioxidant for the stabilization of halogen-free thermoplastic plastic recyclates, in particular against oxidative, thermal, and/or actinic degradation.

New stabilizer compositions and a new method of stabilizing in particular plastic recyclates are proposed that have high effectiveness, environmental friendliness, and a favorable cost structure.

A preferred embodiment provides that the at least one sulfite is an inorganic sulfite, an inorganic disulfite, or an inorganic hydrogen sulfite, preferably a monovalent, bivalent, trivalent, or tetravalent metal, with the metal preferably being an alkali metal, an alkaline earth metal, aluminum, and/or zinc, particularly preferably a sulfite selected from the group consisting of sodium sulfite, potassium sulfite, lithium sulfite, calcium sulfite, magnesium sulfite, aluminum sulfite, zinc sulfite, or an organic sulfite, and mixtures and combinations thereof, with the sulfite in particular being used in its form free of crystal water; and/or
the at least one thiosulfate is a thiosulfate of a monovalent, bivalent, trivalent, or tetravalent metal, with the metal preferably being an alkaline metal, an alkaline earth metal, aluminum, and/or zinc, particularly preferably sodium thiosulfate, with the thiosulfate in particular being used in its form free of crystal water.

The primary antioxidant is preferably selected from the group consisting of H donors, radical scavengers, phenolic antioxidants, (partially) aromatic amines, hydroxylamines, or N-oxides (nitrones), and lactones.

Preferred phenolic antioxidants are here selected from the group consisting of Alkylated monophenols, such as 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutyl phenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, linear or branched nonylphenols such as 2,6-dinonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof;
alkylthiomethylphenols such as 2,4-dioctylthiomethyl-6-tert-butylphenol, 2,4-dioctylthiomethyl-6-methylphenol, 2,4-dioctylthiomethyl-6-ethylphenol, 2,6-didodecylthiomethyl-4-nonylphenol;
hydroquinones and alkylated hydroquinones such as 2,6-di-tert-butyl-4-methoxyphenol, 2,5-di-tert-butylhydroquinone, 2,5-di-tert-amyl hydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxylphenyl)adipate;
tocopherols such as α-, β-, γ-, δ-tocopherol and mixtures thereof (vitamin E);
tocotrienols, tocomonoenols, ubichinols, hydroxytyrosol, flavanoids and flavaonols such as chrysin, quercitin, hesperidin, neohesperidin, naningin, morin, kaempferol, fisein, datiscetin, luteolin, apigenin, taxifolin, isoflavones such as genistein, genistin, daidzein, daidzin, formononetin, anthocyanes such as delphinidin and malvidin, curcumin, carnosoic acid, carnosol, rosemarinic acid, tannin and resveratrol, and carotenoids having alcoholic groups such as beta-cryptoxanthin, lutein, zeaxanthin, or astaxanthin;
hydroxylated thiodiphenylethers such as 2,2′-thiobis(6-tert-butyl-4-methylphenol), 2,2′-thiobis(4-Phenol), 4,4′-thiobis(6-tert-butyl-3-methylphenol), 4,4′-thiobis(6-tert-butyl-2-methylphenol), 4,4′-thiobis(3,6-di-sec-amyl phenol), 4,4′-bis(2,6-dimethyl-4-hydroxyphenyl)disulfide;
alkylide bisphenols such as 2,2′methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclhexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutyl phenol), 2,2′-methylenebis[6-(α-methylbenzyl)-4-nonylphenol], 2,2′-methylenebis[6-(α,α-dimethyl benzyl)-4-nonylphenol], 4,4′-methylenebis(2,6-di-tert-butylphenol, 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol-bis[3,3-bis(3′-tert-butyl-4′-hydroxyphenyl)butyrate], bis(3-tert-butyl-4-hydroxy-5-methylphenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis-(5-tert-butyl-4-hydroxy-2-methylphenyl)-4-n-dodecylmercaptobutane, 1,1,5,5-tetra(5-tert-butyl-4-hydroxy-2-methylphenyl)pentane;
O-, N- and S-benzyl compounds such as 3,5,3′,5′-tetra-tert-butyl-4,4′-dihydroxydibenzylether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate;
hydroxy benzylated malonates such as dioctadecyl-2,2-bis(3,5-di-tert-butyl-2-hydroxybenzyl)malonate, dioctadecyl-2-(3-tert-butyl-4-hydroxy-5-methylbenzyl)malonate, didodecylmercaptoethyl-2,2-bis(3,5-di-tert-butyl-4-hydroxybenzyl)malonate, bis[4-(1,1,3-tetramethyl butyl)phenyl]-2,2-bis(3,3,5-di-tert-butyl-4-hydroxybenzyl)malonate;
aromatic hydroxybenzyl compounds such as 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol;
triazine compounds such as 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxy phenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxphenylethyl)-1,3,5-triazine, 1,3,5-tris(3,5-di-tert-butyl-4-hydroyphenylpropionyl)hexahydro-1,3,5-triazine, 1,3,5-tris(3,5-dicyclohexyl-4-hydroxybenzyl)isocyanurate;
benzyl phosphonates such as dimethyl-2,5-di-tert-butyl-4-hydroxybenzyl phosphonate, diethyl-3,5-di-tert-butyl-4-hydroxybenzyl phosphonate, dioctadecyl-3,5-di-tert-butyl-4-hydroxybenzyl phosphonate, dioctadecyl-5-tert-butyl-4-hydroxy-3-methylbenzyl phosphonate, the calcium salt of the monoethylester of the 3,5-di-tert-butyl-4-hydroxybenzyl phosphonic acid;
acylamino phenols such as 4-hydroxylauranilide, 4-hydroxystearanilide, octyl-N-(3,5-di-tert-butyl-4-hydroxyphenyl)carbamate;
esters of β-(3,5-di-tert-butyl-4-hydroxyphenyl)propionic acid with monovalent or polyvalent alcohols, e.g. methanol, ethanol, n-octanol, i-octanol, octadecanoyl, 1,6-hexanediol, 1,9-nonanediol, ethylene glycol, 1,2-propanediol, neopentyl glycol, thiodiethylene glycol, diethylene glycole, triethylene glycol, pentaerythritol, tris(hydroxyethyl)isocyanurate, N,N′-bis(hydroxyethyl)oxamide, 3-thiaundecanol, 3-thiapentadecanol, trimethyl hexanediol, trimethylolpropane, 4-hydroxymethyl-1-phospha-2,6,7-trioxabicyclo[2.2.2]octane;
esters of β-(5-tert-butyl-4-hydroxy-3-methylphenyl)propionic acid with monovalent or polyvalent alcohols such as methanol, ethanol, n-octanol, i-octanol, octadecanol, 1,6-hexanediol, 1,9-nonanediol, ethylene glycol, 1,2-propanediol, neopentyl glycol, thio diethylene glycol, diethylene glycol, triethylene glycole, pentaerythritol, tris(hydroxyethyl)isocyanurate, N,N′-bis(hydroxyethyl)oxamide, 3-thiaundecanol, 3-thiapentadecanol, trimethyl hexanediol, trimethylolpropane, 4-hydroxymethyl-1-phospha-2,6,7-trioxabicyclo[2.2.2]octane, 3,9-bis[2-{3-(3-tert-butyl-4-hydroxy-5-methylphenyl)propionyloxy}-1,1-dimethylethyl]-2,4,8,10-tetraoxaspiro[5.5]undecane;
esters of β-(3,5-dicyclohexyl-4-hydroxyphenyl)propionic acid with monovalent or polyvalent alcohols such as methanol, ethanol, octanol, octadecanoyl, 1,6-hexanediol, 1,9-nonanediol, ethylene glycol, 1,2-propanediol, neopentyl glycol, thiodiethylene glycol, diethylene glycol, triethylene glycole, pentaerythritol, tris(hydroxyethyl)isocyanurate, N,N′-bis(hydroxyethyl) oxamide, 3-thiaundecanol, 3-thiapentadecanol, trimethyl hexanediol, trimethylolpropane, 4-hydroxymethyl-1-phospha-2,6,7-trioxabicyclo[2.2.2]octane;
esters of (3,5-di-tert-butyl-4-hydroxyphenyl acetic acid with monovalent or polyvalent alcohols, e.g. methanol, ethanol, octanol, octadecanol, 1,6-hexanediol, 1,9-nonanediol, ethylene glycol, 1,2-propanediol, neopentyl glycol, thio diethylene glycol, diethylene glycol, triethylene glycol, pentaerythritol, tris(hydroxyethyl)isocyanurate, N,N′-bis(hydroxyethyl)oxamide, 3-thiaundecanol, 3-Thiapentadecanol, trimethyl hexanediol, trimethylolpropane, 4-hydroxymethyl-1-phospha-2,6,7-trioxabicyclo[2.2.2]octane;
amides of the β-(3,5-di-tert-butyl-4-hydroxyphenyl)propionic acid such as N,N′-bis(3,5-di-tert-butyl-4-hydroxyphenylpropionyl)hexamethylene diamide, N,N′-bis(3,5-di-tert-butyl-4-hydroxyphenylpropionyl)hexamethylene diamide, N,N′-bis(3,5-di-tert-butyl-4-hydroxyphenylpropionyl)hexamethylene diamide, N,N′-bis(3,5-di-tert-butyl-4-hydroxyphenyl propionyl)hydrazide, N,N′-bis[2-(3-[3,5-di-tert-butyl-4-hydroxyphenyl]propionyloxy)ethyl]oxamide (Naugard®XL-1, marketed by Uniroyal);
ascorbic acid (vitamin C);

Further particularly preferred phenolic antioxidants are tocopherols (vitamin E), tocotrienols, tocomonoenols, hydroxytyrosol, flavanols such as chrysin, quercitin, hesperidin, neohesperidin, naringin, morin, kaempferol, fisetin, and tannins, vitamin E (tocopherol) is very particularly preferred.

Preferred usable amine antioxidants are selected from the group consisting of N,N′-di-isopropyl-p-phenylene diamine, N,N′-di-sec-butyl-p-phenylene diamine, N,N′-bis(1,4-dimethyl pentyl)-p-phenylene diamine, N,N′-bis(1-ethyl-3-methyl pentyl)-p-phenylene diamine, N,N′-bis(1-methyl heptyl)-p-phenylene diamine, N,N′-dicyclohexyl-p-phenylene diamine, N,N′-diphenyl-p-phenylene diamine, N,N′-bis(2-naphthyl)-p-phenylene diamine, N-isopropyl-N′-phenyl-p-phenylene diamine, N-(1,3-dimethyl butyl)-N′-phenyl-p-phenylene-diamine, N-(1-methyl heptyl)-N′-phenyl-p-phenylene diamine, N-cyclohexyl-N′-phenyl-p-phenylene diamine, 4-(p-toluolsulfamoyl)diphenylamine, N,N′-dimethyl-N,N′-di-sec-butyl-p-phenylene diamine, diphenylamine, N-allyl diphenylamine, 4-isopropoxydiphenylamine, N-phenyl-1-naphthylamine, N-(4-tert-octyl phenyl)-1-naphthylamine, N-phenyl-2-naphthylamine, octylated diphenylamine, e.g. p,p′-di-tert-octyl diphenylamine, 4-n-butyl aminophenol, 4-butyryl aminophenol, 4-nonanoyl aminophenol, 4-dodecanoyl aminophenol, 4-octadecanoyl amino-phenol, bis(4-methoxyphenyl)amine, 2,6-di-tert-butyl-4-dimethylaminomethyl-phenol, 2,4′-diamino diphenylmethane, 4,4′-diamino diphenylmethane, N,N,N′,N′-tetra-methyl-4,4′-diamino diphenylmethane, 1,2-bis[(2-methyl-phenyl)amino]ethane, 1,2-bis(phenylamino)propane, (o-tolyl)biguanide, bis[4-(1′,3′-dimethyl butyl)phenyl]amine, tert-octylated N-phenyl-1-naphthylamine, a mixture of monoalkylated and dialkylated tert-butyl/tert-octyldiphenylamines, a mixture of monoalkylated and dialkylated nonyldiphenylamines, a mixture of monoalkylated and dialkylated dodecyldiphenylamines, a mixture of monoalkylated and dialkylated isopropyl/isohexyl-diphenylamines, a mixture of monoalkylated and dialkylated tert-butyldiphenylamines, 2,3-dihydro-3,3-dimethyl-4H-1,4-benzothiazine, phenothiazine, a mixture of monoalkylated and dialkylated tert-butyl/tert-octylphenothiazines, a mixture of monoalkylated and dialkylated tert-octylphenothiazines, N-llylphenothiazine, N,N,N′,N′-tetraphenyl-1,4-diamino but-2-ene and mixtures or combinations hereof.

Preferred hydroxylamines or N-oxides (nitrones) are selected from the group consisting of N,N-dialkylhydroxylamines, N,N-dibenzyl hydroxylamine, N,N-dilaurylhydroxylamine, N,N-distearylhydroxylamine, N-benzyl-α-phenylnitrone, N-octadecyl-α-hexadecyl nitrone, and Genox EP (SI Group) in accordance with the formula:

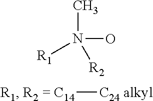

For the purposes of the present invention, preferred lactones are selected from the group consisting of benzofuranones and indolinones, in particular selected from the group consisting of 3-(4-(2-acetoxyethoxy)phenyl]-5,7-di-tert-butyl-benzofuran-2-one, 5,7-di-tert-butyl-3-[4-(2-stearoyloxyethoxy)phenyl]benzofuran-2-one, 3,3′-bis[5,7-di-tert-butyl-3-(4-(2-hydroxy ethoxy]phenyl)benzofuran-2-one), 5,7-di-tert-butyl-3-(4-ethoxy phenyl)benzofuran-2-one, 3-(4-acetoxy-3,5-dimethylphenyl)-5,7-di-tert-butyl-benzofuran-2-one, β-(3,5-dimethyl-4-pivaloyloxyphenyl)-5,7-di-tert-butyl-benzofuran-2-one, β-(3,4-dimethylphenyl)-5,7-di-tert-butyl-benzofuran-2-one, 3-(2,3-dimethylphenyl)-5,7-di-tert-butyl-benzofuran-2-one as well as lactones that additionally comprise a phosphite group such as

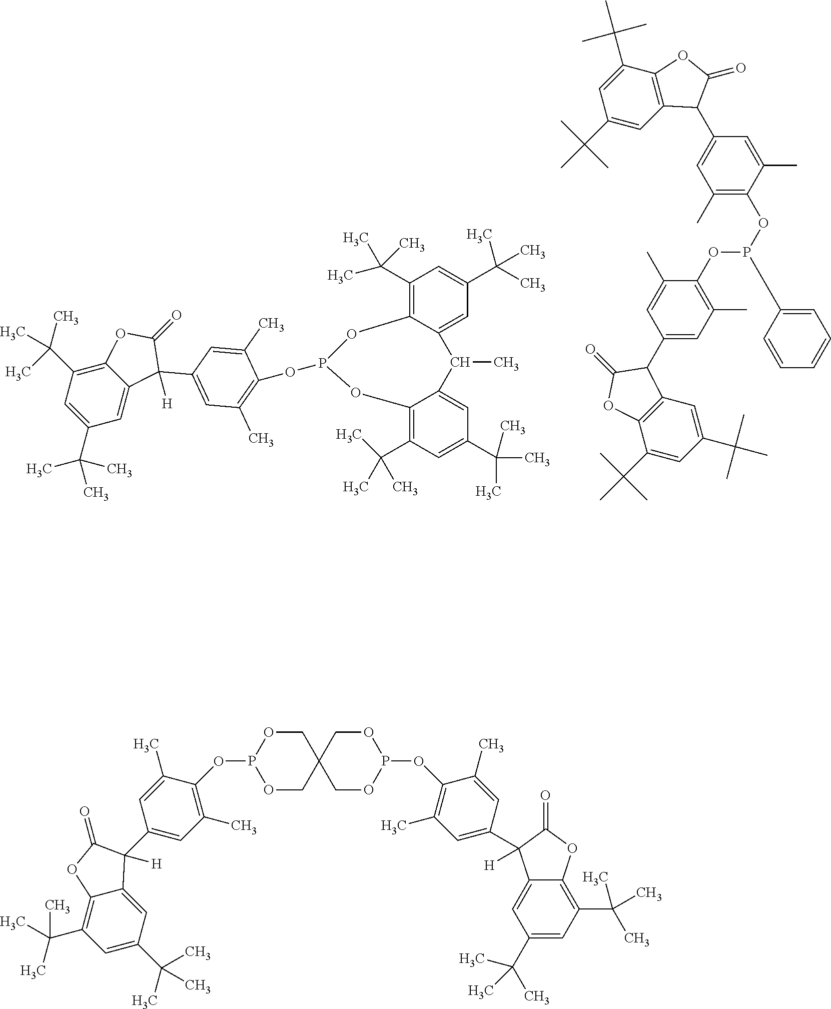

It is equally possible to use mixtures and combinations of the aforesaid compounds.

The phenolic antioxidants selected from the group consisting of the following compounds are in particular preferred

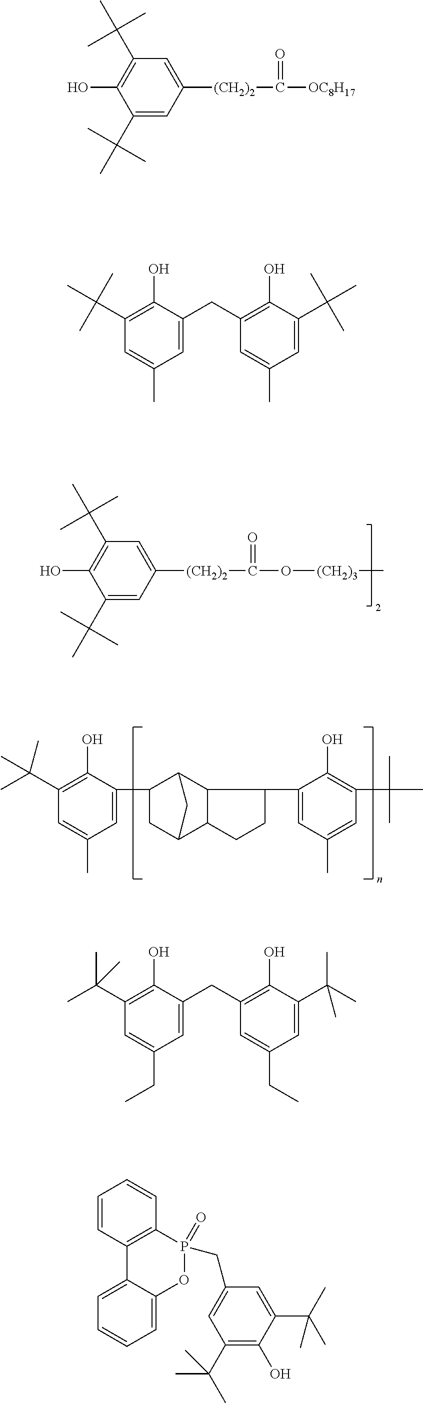

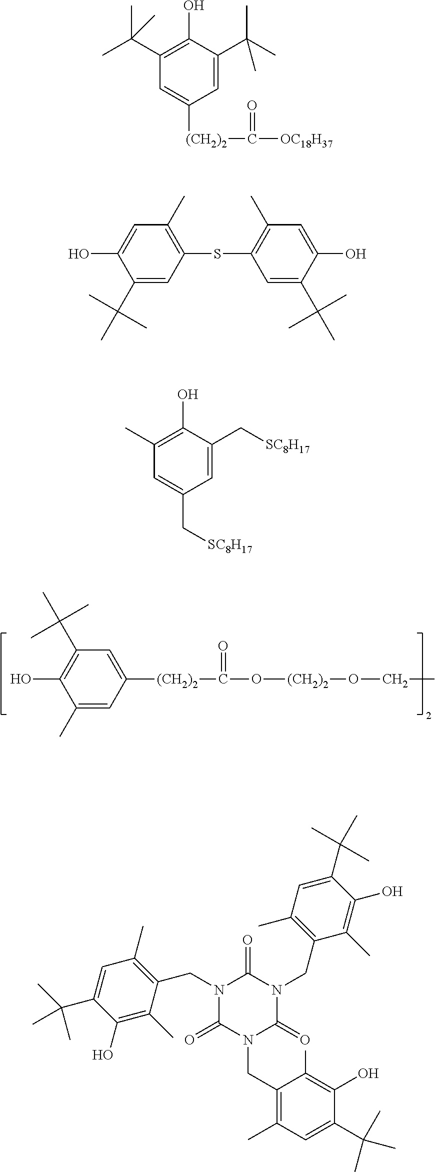

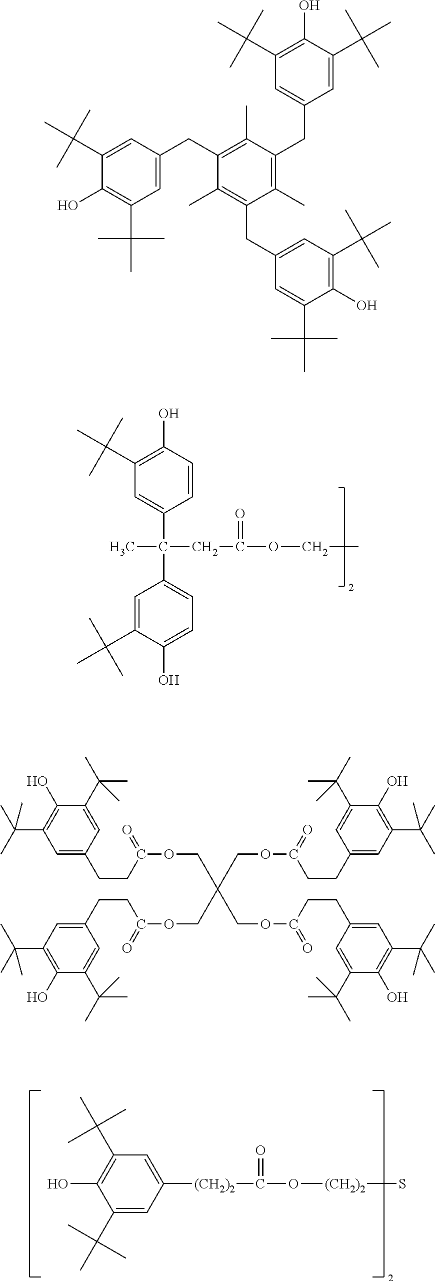

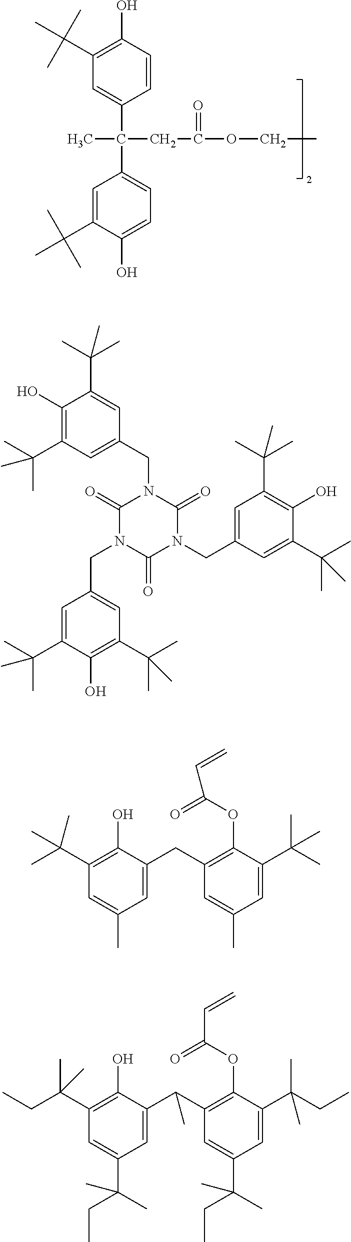

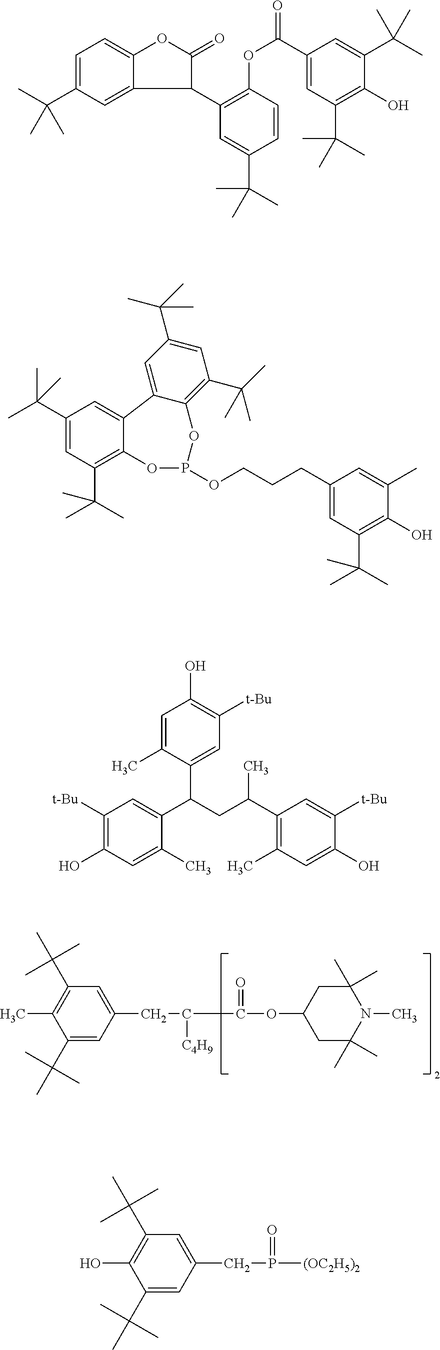

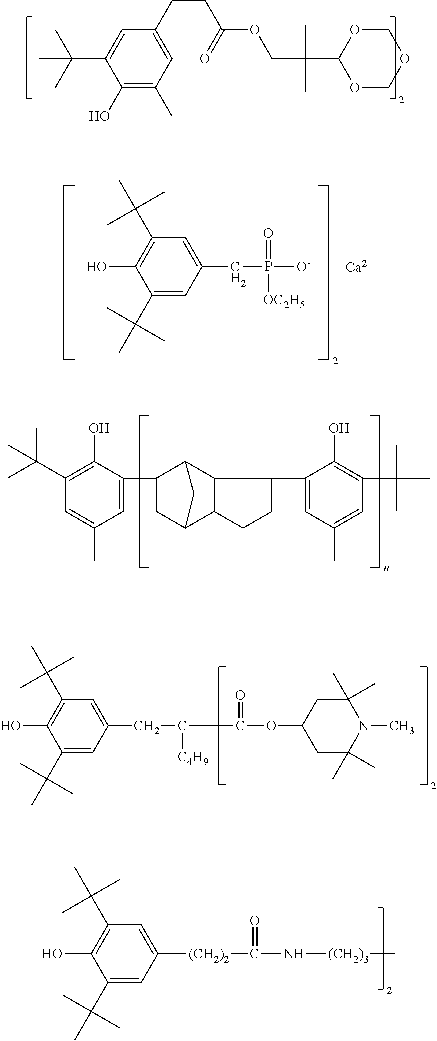

Preferred aminic antioxidants are selected from the group consisting of the following compounds:

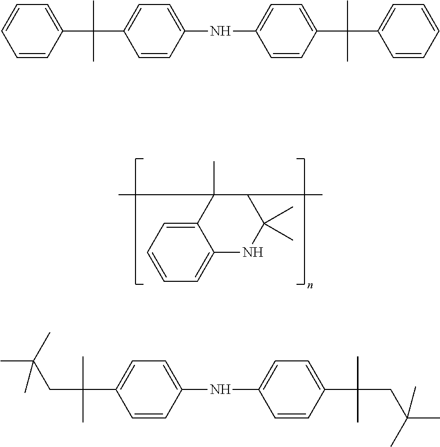

where n is 2 to 100.

With respect to the totality of the halogen-free thermoplastic plastic recyclates, the stabilizer composition will preferably use recyclates in a weight ratio of 0.01 to 10.00 wt %, preferably 0.02 to 5.00 wt %, and particularly preferably 0.05 to 2.00 wt %.

It is furthermore advantageous if the totality of the at least one sulfite and/or of the at least one thiosulfate and the totality of the at least one primary antioxidant is/are used in a weight ratio of 1:99 to 99:1, preferably 20:80 to 80:20, further preferably from 30:70 to 70:30, particularly preferably from 40:60 to 60:40.

The halogen-free thermoplastic plastic recyclates can in particular be recyclates of the polymers listed below:
a) recycled polymers of olefins or diolefins such as polyethylene (LDPE, LLDPE, VLDPE, ULDPE, MDPE, HDPE, and UHMWPE), metallocene PE (m-PE), polypropylene, polyisobutylene, poly-4-methyl-pentene-1, polybutadiene, polyisoprene, such as natural rubber (NR), polycyclooctene, polyalkylene-carbon monoxide copolymers, and copolymers in the form of statistical or block structures such as polypropylene-polyethylene (EP), EPM or EPDM with e.g. 5-ethylidene-3-norbornene as a comonomer, ethylene-vinyl acetate (EVA), ethylene-acrylic ester such as ethylene butyl acrylate, ethylene-acrylic acid and their salts (ionomers), and terpolymers such as ethylene acrylic acid glycidyl(meth)acrylate, graft polymers such as polypropylene graft maleic acid anhydride, polypropylene graft-acrylic acid, polyethylene graft acrylic acid, polyethylene polybutylacrylate graft maleic acid hydride, and blends such as LDPE/LLDPE or also long chain branched polypropylene copolymers that are prepared with alpha olefins as comonomers such as with 1-butene, 1-hexene, 1-octene, or 1-octadecene.,
b) recycled polystyrene, polymethyl styrene, poly-alpha-methyl styrene, polyvinyl naphthalene, polyvinyl biphenyl, polyvinyl toluol, styrene butadiene (SB), styrene butadiene styrene (SBS), styrene ethylene butylene styrene (SEBS), styrene ethylene propylene styrene, styrene isoprene, styrene isoprene styrene (SIS), styrene butadiene acrylonitrile (ABS), styrene acrylonitrile (SAN), styrene acrylonitrile acrylate (ASA), styrene ethylene, styrene maleic acid anhydride polymers, incl. corresponding graft copolymers such as styrene on butadiene, maleic acid anhydride on SBS or SEBS, and graft copolymers of methylmethacrylate, styrene butadiene, and ABS (MABS), and hydrated polystyrene derivatives such as polyvinyl cyclohexane,
c) recycled polymers of unsaturated esters such as polyacrylates and polymethacrylates such as polymethyl methacrylate (PMMA), polybutyl acrylate, polylauryl acrylate, poly stearyl acrylate, polyglycidyl methacrylate, polyacrylonitrile, polyacrylamides, copolymers such as polyacrylonitrile-poly alkyl acrylate,
d) polymers of unsaturated alcohols and derivatives such as polyvinyl alcohol, polyvinyl acetate, polyvinyl butyral, poly allyl phthalate, poly allyl melamine,
e) recycled polyacetates such as polyoxymethylene (POM) or copolymers with e.g., butanal, polyphenylene oxides and blends with polystyrene or polyamides,
f) recycled polymers of cyclic ethers such as polyethylene glycol, polypropylene glycol, polyethylene oxide, polypropylene oxide, polytetrahydrofuran,
g) recycled polyphenylene oxides and blends with polystyrene and/or polyamides,
h) recycled polyurethanes of hydroxy terminated polyethers or polyesters and aromatic or aliphatic isocyanates such as 2,4- or 2,6-toluylene diisocyanate or methylene diphenyl diisocyanate, in particular also linear polyurethanes (TPU), polyureas,
i) recycled polyamides such as polyamide-6, 6.6, 6.10, 4.6, 4.10, 6.12, 10.10, 10.12, 12.12, polyamide 11, polyamide 12, and (partially) aromatic polyamides such as poly phthalamides, e.g. prepared from terephthalic acid and/or isophthalic acid and aliphatic diamines such as hexamethylene diamine or n-xylylene diamine or from aliphatic dicarboxylic acids such as adipic acid or sebacic acid and aromatic diamines such as 1,4- or 1,3-diamino benzol, blends of different polyamides such as PA-6 and PA 6.6 or blends of polyamides and polyolefins such as PA/PP,
j) recycled polyamides, polyamide imides, polyether imides, polyester imides, poly(ether)ketones, polysulfones, polyether sulfones, polyaryl sulfones, polyphenylene sulfides, polybenzimidazoles, polyhydantoines,
k) recycled polyesters of aliphatic or aromatic dicarboxylic acids and diols or of hydroxy carboxylic acids such as polyethylene terephthalate (PET), polybutylene terephthalate (PBT) polypropylene terephthalate (PTI), polyethylene naphthalate (PEN), poly-1,4-dimethylol cyclohexane terephthalate, polyhydroxy benzoate, polyhydroxy naphthalate, poly lactic acid (PLA), polyhydroxy butyrate (PHB), polyhydroxy valerate (PHV), polyethylene succinate, polytetramethylene succinate, polycaprolactone,
l) recycled polycarbonates, polyester carbonates, and blends such as PC/ABS, PC/PBT, PC/PET/PBT, PC/PA,
m) recycled cellulose derivatives such as cellulose nitrate, cellulose acetate, cellulose propionate, cellulose butyrate,
n) and mixtures, combinations, or blends of two or more of the above-named polymers.

The thermoplastic plastic recyclate is particularly preferably selected from the group consisting of polymers of olefins or diolefins such as polyethylene, in particular LDPE, LLDPE, VLDPE. ULDPE, MDE, HDPE, and UHMWPE, metallocene PE (m-PE), polypropylene, polyisobutylene, poly-4-methyl-pentene-1, polybutadiene, polyisoprene, polycyclooctene, polyalkylene-carbon monoxide copolymers, and corresponding copolymers in the form of statistical or block structures such as polypropylene-polyethylene (EP), EPM or EPDM, ethylene-vinyl acetate (EVA), ethylene-acrylic ester such as ethylene butyl acrylate, ethylene-acrylic acid glycidyl acrylate, and corresponding graft polymers such as polypropylene maleic acid anhydride, polypropylene-g-acrylic acid, and polyethylene acrylic acid.

The one thermoplastic is very particularly preferably a polyolefin recyclate. The thermoplastic plastic recyclate can, for example, be polypropylene, that is in particular a polypropylene recyclate homopolymer or copolymer, or polyethylene, that is in particular a polyethylene recyclate, e.g. HDPE, LDPE, LLDPE or mixtures of different polyethylenes such as HDPE, MDPE, LDPE, LLDPE or of PE and PP.

The stabilizer composition can be used in a further preferred embodiment in combination with at least one additive, in particular at least one additive selected from the group consisting of secondary antioxidants, UV absorbers, light stabilizers, metal deactivators, filler deactivators, antiozonants, nucleation agents, anti-nucleation agents, toughening agents, mold lubricants, rheological modifiers, thixotropic agents, chain extenders, processing aids, demolding aids, flame retardants, pigments, dyes, optical brighteners, antimicrobial active agents, antistatic agents, slip agents, anti-blocking agents, coupling agents, crosslinking agents, anti-cross-linking agents, hydrophilization agents, hydrophobing agents, bonding agents, dispersing agents, compatibilizers, oxygen scavengers, acid scavengers, expanding agents, degradation additives, defoaming agents, odor scavengers, marking agents, anti-fogging agents, fillers, reinforcement materials, polyol costabilizers, compatibilizers, and mixtures thereof.

In a preferred embodiment, the compositions in particular comprise light stabilizers, fillers, acid scavengers, polyol costabilizers, and/or compatibilizers.

Preferred fillers are calcium carbonate, silicates, talcum, mica, kaolin, metal oxides and metal hydroxides, black carbon, graphite, wood flour, or fibers of natural products such as cellulose. Further suitable fillers are hydrotalcites or zeolites or phyllosilicates such as montmorillonite, bentonite, beidellite, mica, hectorite, saponite, vermiculite, ledikite, magadiite, illite, kaolinite, wollastonite, attapulgite.

Suitable secondary antioxidants are in particular phosphites or phosphonites such as
triphenylphosphite, diphenylalkylphosphites, phenyldialkylphosphites, tri(nonylphenyl)phosphite, trilaurylphosphites, trioctadecylphosphite, distearylpentaerythritoldiphosphite, tris-(2,4-di-tert-butylphenyl phosphite, diisodecylpentaerythritoldiphosphite, bis(2,4-di-tert-butylphenyl)pentaerythritoldiphosphite, bis(2,4-di-cumylphenyl)pentaerythritoldiphosphite, bis(2,6-di-tert-butyl-4-methylphenyl)pentaerythritoldiphosphite, diisodecyloxypentaerythritoldiphosphite, bis(2,4-di-tert-butyl-6-methylphenyl)pentaerythritoldiphosphite, bis(2,4,6-tris(tert-butylphenyl)pentaerythritoldiphosphite, tristearylsorbitoltriphosphite, tetrakis(2,4-di-tert-butylphenyl)-4,4′-biphenylene diphosphonite, 6-isooctyloxy-2,4,8,10-tetra-tert-butyl-12H-dibenz[d,g]-1,3,2-dioxaphosphocine, bis(2,4-di-tert-butyl-6-methylphenyl)methylphosphite, bis(2,4-di-tert-butyl-6-methylphenyl)ethylphosphite, 6-fluoro-2,4,8,10-tetra-tert-butyl-12-methyl-dibenz[d,g]-1,3,2-dioxaphosphocine, 2,2′2″-nitrilo[triethyltris(3,3″,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl))phosphite, 5-butyl-5-ethyl-2-(2,4,6-tri-tert-butylphenoxy)-1,3,2-dioxaphosphirane.

Particularly preferred phosphites are:

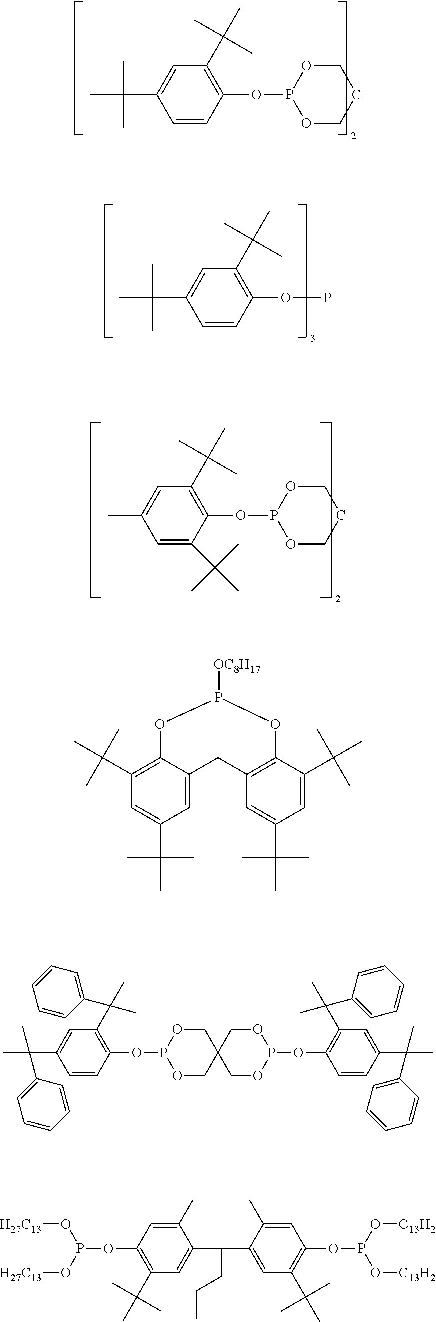

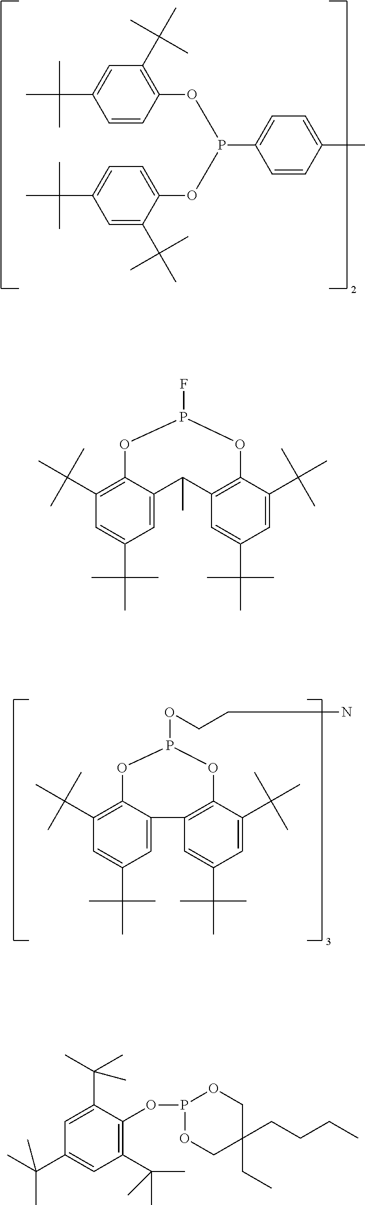

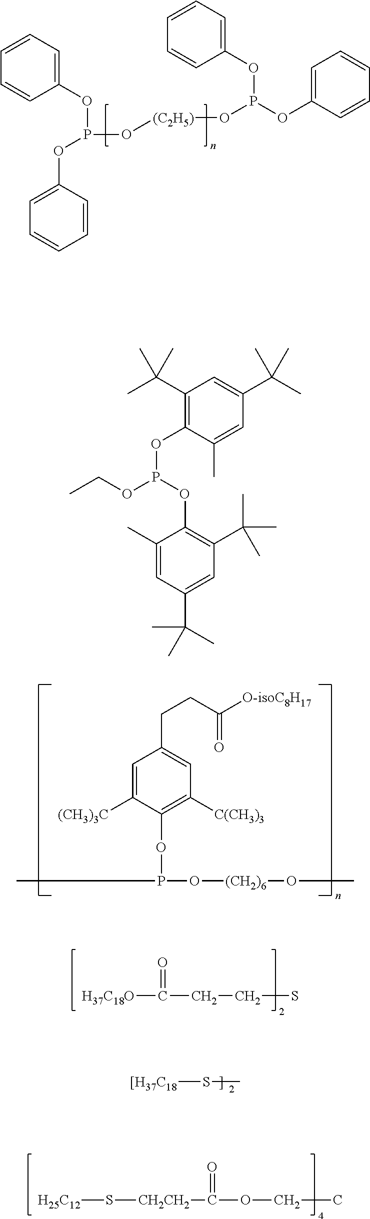

where n=3-100

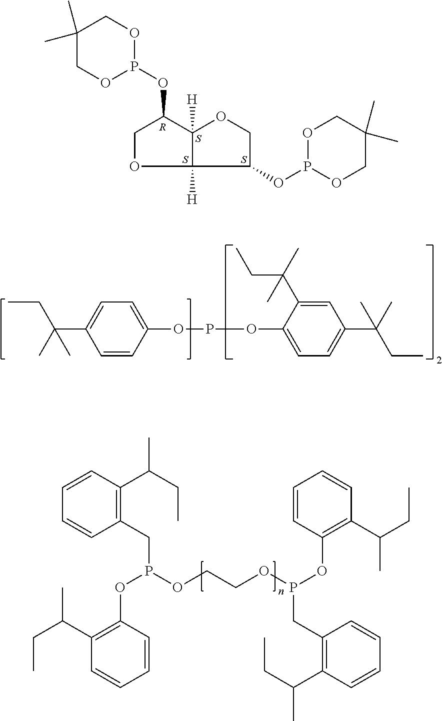

A preferred phosphonite is:

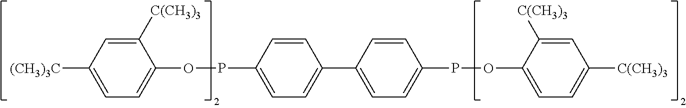

Suitable secondary antioxidants are furthermore organosulfur compounds such as sulfides and disulfides, e.g., distearylthiodipropionate, dilaurylthiodipropionate, ditridecyldithiopropionate, ditetradecylthiodipropionate, 3-(dodecylthio), 1,1′-[2,2-bis[[3-(dodecylthio)-I-oxopropoxy]methyl]1,3-propandiyl] propanoic acid ester. The following structures are preferred:

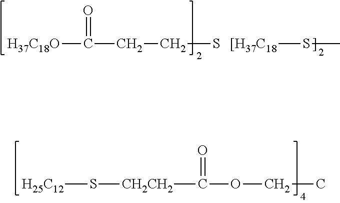

Suitable acid scavengers (“antacids”) are salts of monovalent, bivalent, trivalent, or quadrivalent metals, preferably alkali metals, alkaline earth metals, aluminum or zinc, in particular formed with fatty acids such as calcium stearate, magnesium stearate, zinc stearate, aluminum stearate, calcium laurate, calcium behenate, calcium lactate, calcium stearoyl-2-lactate. Further classes of suitable acid scavengers are hydrotalcites, in particular synthetic hydrotalcites on the basis of aluminum, magnesium and zinc, hydrocalumites, zeolites, alkaline earth metals, in particular calcium oxide and magnesium oxide and zinc oxide, alkaline earth carbonates, in particular calcium carbonate, magnesium carbonate and dolomite, and hydroxides, in particular brucite (magnesium hydroxide).

Suitable costabilizers are furthermore polyols, in particular alditols or cyclitols. Polyols are e.g. pentaerythritol, dipentaerythritol, tripentaerythritol, short chain polyether polyols or short chain polyester polyols, and hyperbranched polymers/oligomers, or dendrimers having alcohol groups e.g.

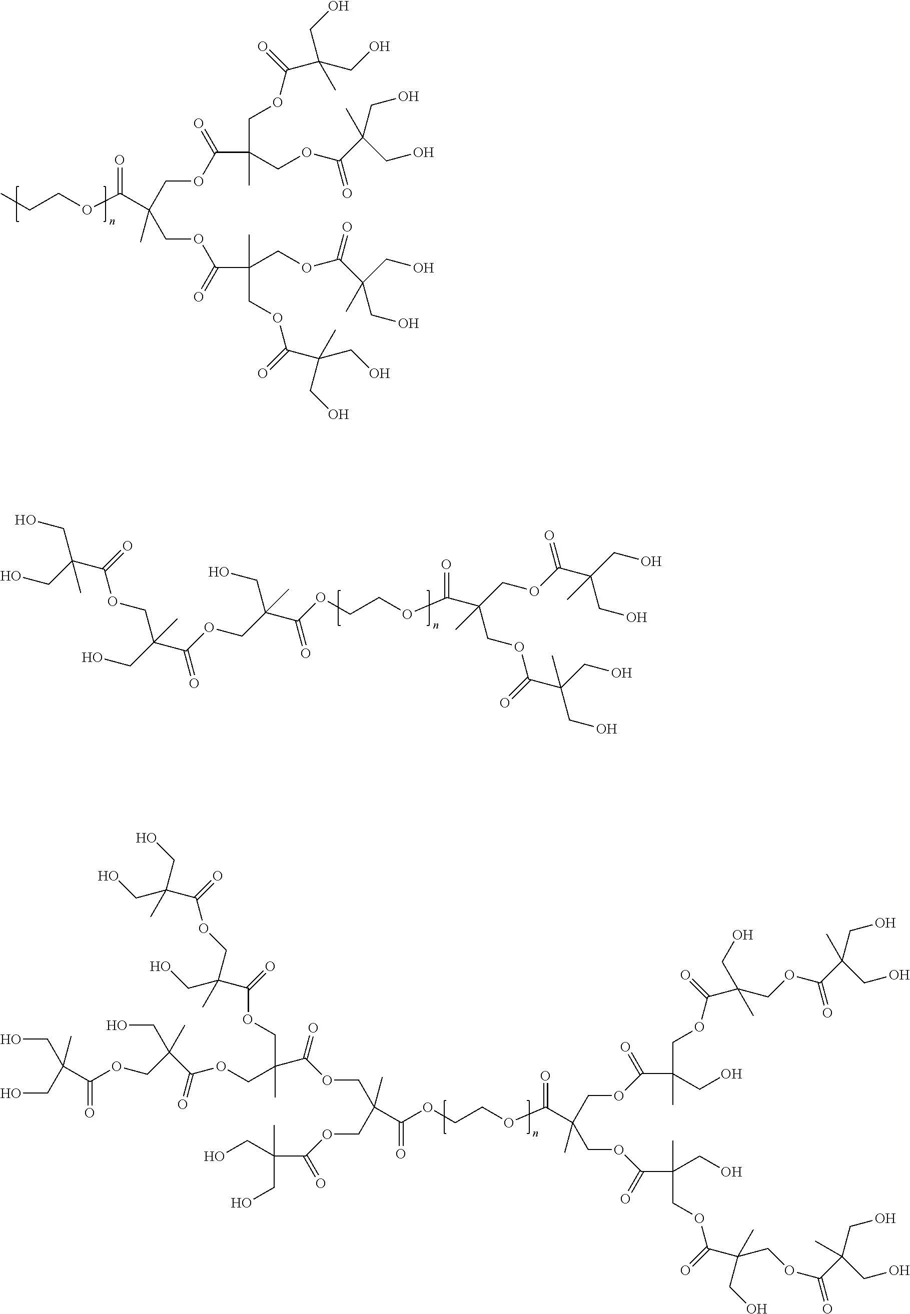

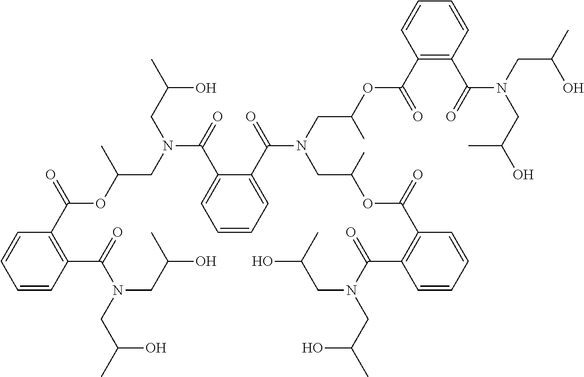 [SMILES: CC(O)CN(CC(C)O)C(=O)c1ccccc1C(=O)OC(C)CN(CC(C)O)C(=O)c1ccccc1C(=O)N(CC(C)OC(=O)c1ccccc1C(=O)N(CC(C)O)CC(C)O)CC(C)OC(=O)c1ccccc1C(=O)N(CC(C)O)CC(C)O]

The at least one alditol is preferably selected from the group consisting of threitol, erythritol, galactol, mannitol, ribitol, sorbitol, xylitol, arabitol, ismaltol, lactitol, maltitol, altritol, iditol, maltotritol, and hydrated oligosaccharides and polysaccharides with polyol end groups and mixtures thereof. The at least one preferred alditol is particularly preferably selected from the group consisting of erythritol, mannitol, isomaltol, maltitol, and mixtures thereof.

Examples of further suitable sugar alcohols are heptitols and octitols: meso-glycero-allo-heptitol, D-glycero-D-altro-heptitol, D-glycero-D-manno-heptitol, meso-glycero-gulo-heptitol, D-glycero-D-galacto-heptitol (perseitol), D-glycero-D-gluco-heptitol, L-glycero-D-gluco heptitol, D-erythro-L-galacto-octitol, D-threo-L-galacto-octitol.

In particular, the at least one cyclitol may be selected from the group consisting of inositol (myo, scyllo-, D-chiro-, L-chiro-, muco-, neo-, allo-, epi- and cis-inositol), 1,2,3,4-tetrahydroxycyclohexane, 1,2,3,4,5-pentahydroxycyclohexane, quercitol, viscumitol, bornesitol, conduritol, ononitol, pinitol, pinpollitol, quebrachitol, ciceritol, quinic acid, shikimic acid and valienol; in this case myo-inositol is preferred.

Suitable light stabilizers are, for example, compounds based on 2-(2′-hydroxyphenyl) benzotriazoles, 2-hydroxy benzophenones, esters of benzoic acids, acrylates, oxamides, and 2-(2-hydroxyphenyl)-1,3,-5-triazines.

Suitable 2-(2′-hydroxyphenyl)benzotriazoles are, for example, 2-(2′-hydroxy-5′methylphenyl)benzotriazole, 2-(3′,5′-di-tert-butyl-2′-hydroxyphenyl)benzotriazole, 2-(5′-tert-butyl-2′-hydroxy-phenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl-5-chlorobenzotriazole, 2-(3′-sec-butyl-5′-tert-butyl-2′-hydroxy-phenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis(α,α-dimethylbenzyl)-2′-hydroxyphenyl)benzotriazole, 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylenebis[4-(1,1,3,3-tetramethylbutyl)-6-benzotriazole-2-ylphenol]; the product of the transesterification of 2-[3′-tert-butyl-5′-(2-methoxycarbonylethyl)-2′-hydroxyphenyl]-2H-benzotriazole with polyethyleneglycol 300; [R—CH₂CH₂—COO—CH₂CH₂—]-₂, where R=3′-tert-butyl-4′-hydroxy-5′-2H-benzotriazole-2-ylphenyl, 2-[2′-hydroxy-3′-(α,α-dimethylbenzyl)-5′-(1,1,3,3-tetramethylbutyl)phenyl]benzotriazole, 2-[2′-hydroxy-3′-(1,1,3,3-tetramethylbutyl)-5′-(α,α-dimethylbenzyl)phenyl]benzotriazole.

Suitable 2-hydroxybenzophenones are, for example, 4-hydroxy-, 4-methoxy-, 4-octyloxy-, 4-decyloxy-4-dodecyloxy, 4-benzyloxy, 4,2′,4′-trihydroxy- and 2′-hydroxy-4,4′-dimethoxy derivatives of the 2-hydroxy benzophenones.

Suitable acrylates are, for example, ethyl-α-cyano-β,β-diphenylacrylate, isooctyl-α-cyano-β,β-diphenylacrylate, methyl-α-carbomethoxycinnamate, methyl-α-cyano-β-methyl-β-methoxycinnamate, butyl-α-cyano-β-methyl-β-methoxycinnamate, methyl-α-carbomethoxy-β-methoxycinnamate and N-(β-carbomethoxy-β-cyanovinyl)-2-methylindoline.

Suitable esters of benzoic acids are, for example, 4-tert-butylphenylsalicylate, phenylsalicylate, octylphenylsalicylate, dibenzoylresorcinol, bis(4-tert-butylbenzoyl)resorcinol, benzoylresorcinol, 2,4-di-tert-butylphenyl-3,5-di-tert-butyl-4-hydroxybenzoate, hexadecyl-3,5-di-tert-butyl-4-hydroxybenzoate, octadecyl-3,5-di-tert-butyl-4-hydroxybenzoate, 2-methyl-4,6-di-tert-butylphenyl-3,5-di-tert-butyl-4-hydroxybenzoate.

Suitable oxamides are, for example, 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethoxanilide, N,N′-bis(3-dimethylaminopropyl)oxamide, 2-ethoxy-5-tert-butyl-2′-ethoxanilide and its mixtures with 2-ethoxy-2′-ethyl-5,4′-di-tert-butoxanilide, mixtures of o- and p-methoxy-disubstituted oxanilides and mixtures of o- and p-ethoxy-disubstituted oxanilides.

Suitable 2-(2-hydroxyphenyl)-1,3,5-triazines are, for example, 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)-phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl-1,3,5-triazine.

Suitable metal deactivators are, for example, N,N′-diphenyloxamide, N-salicylal-N′-salicyloylhydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyldihydrazide, oxanilide, isophthaloyldihydrazide, sebacoyl-bis-phenylhydrazide, N,N′-diacetyladipoyldihydrazide, N,N′-bis(salicyloyl)oxylyldihydrazide, N,Ne-bis(salicyloyl)thiopropionyldihydrazide.

Particularly preferred as metal deactivators are

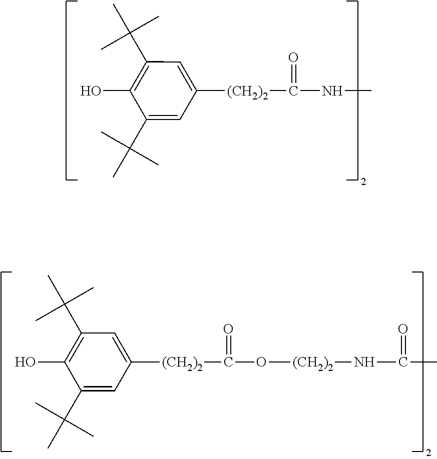

Suitable hindered amines are, for example 1,1-bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl)-n-butyl-3,5-di-tert-butyl-4-hydroxybenzylmalonate, the condensation product from 1-(2-hydroxyethyl)-2,2,6,6-tetramethyl-4-hydroxypiperidine and succinic acid, linear or cyclic condensation products of N,N′-bis(2,2,6,6-tetramethyl-4-piperidyl)hexamethylene diamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butane tetracarboxylate, 1,1′-(1,2-ethandiyl)-bis(3,3,5,5-tetramethylpiperazinone), 4-benzoyl-2,2,6,6-tetramethylpiperidine, 4-stearyloxy-2,2,6,6-tetramethylpiperidine, linear or cyclic condensation products of N,N′-bis(2,2,6,6-tetramethyl-4-piperidyl)hexamethylene diamine and 4-morpholino-2,6-dichloro-1,3,5-triazine, the reaction product of 7,7,9,9-tetramethyl-2-cycloundecyl-1-oxa-3,8-diaza-4-oxospiro-[4,5]decane and epichlorhydrine.

The sterically hindered N—H, N-alkyl such as N-methyl or N-octyl, the N-alkoxy derivatives such as N-methoxy or N-octyloxy, the cycloalkyl derivatives such as N-cyclohexyloxy and the N-(2-hydroxy-2-methylpropoxy) analogs are also each included in the above-given structures here.

Preferred hindered amines furthermore have the following structures:

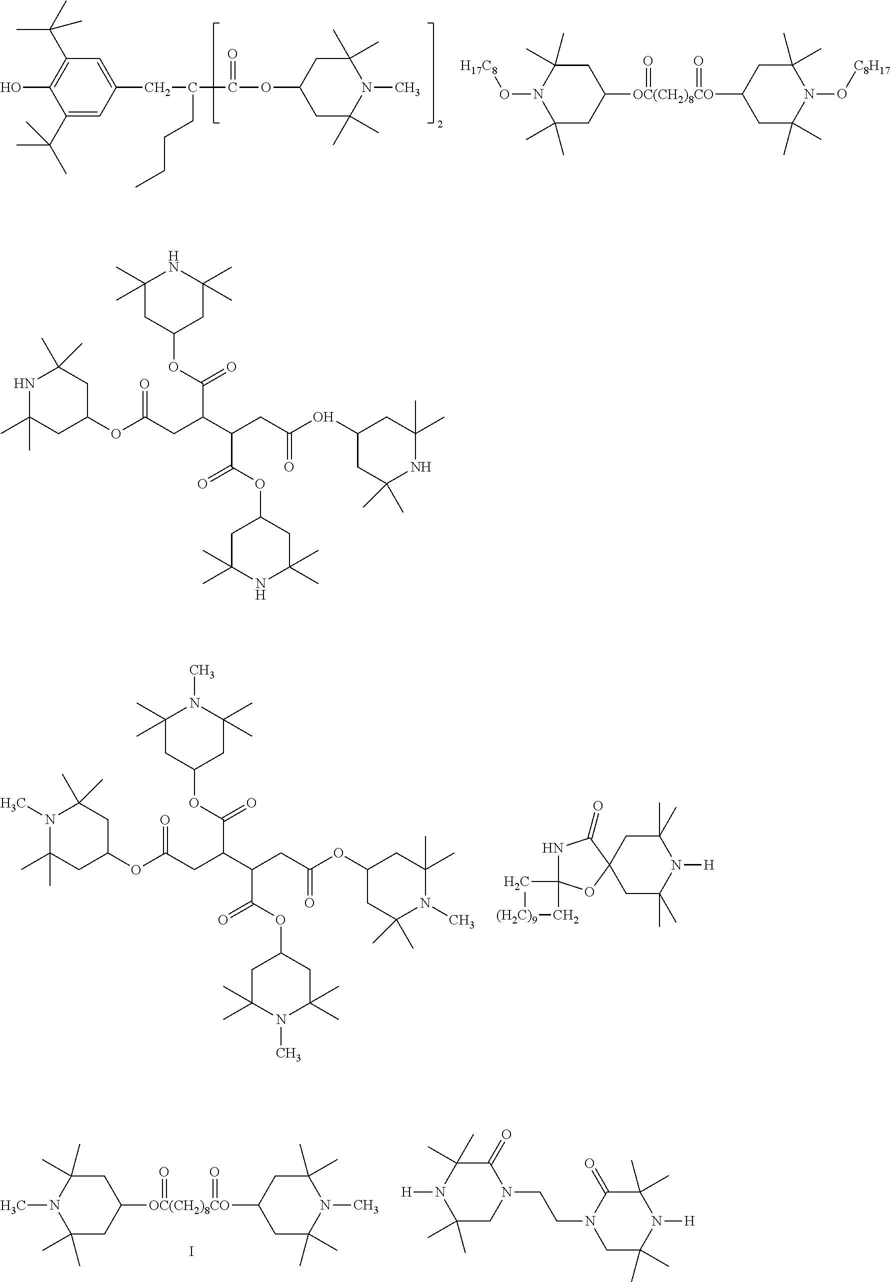

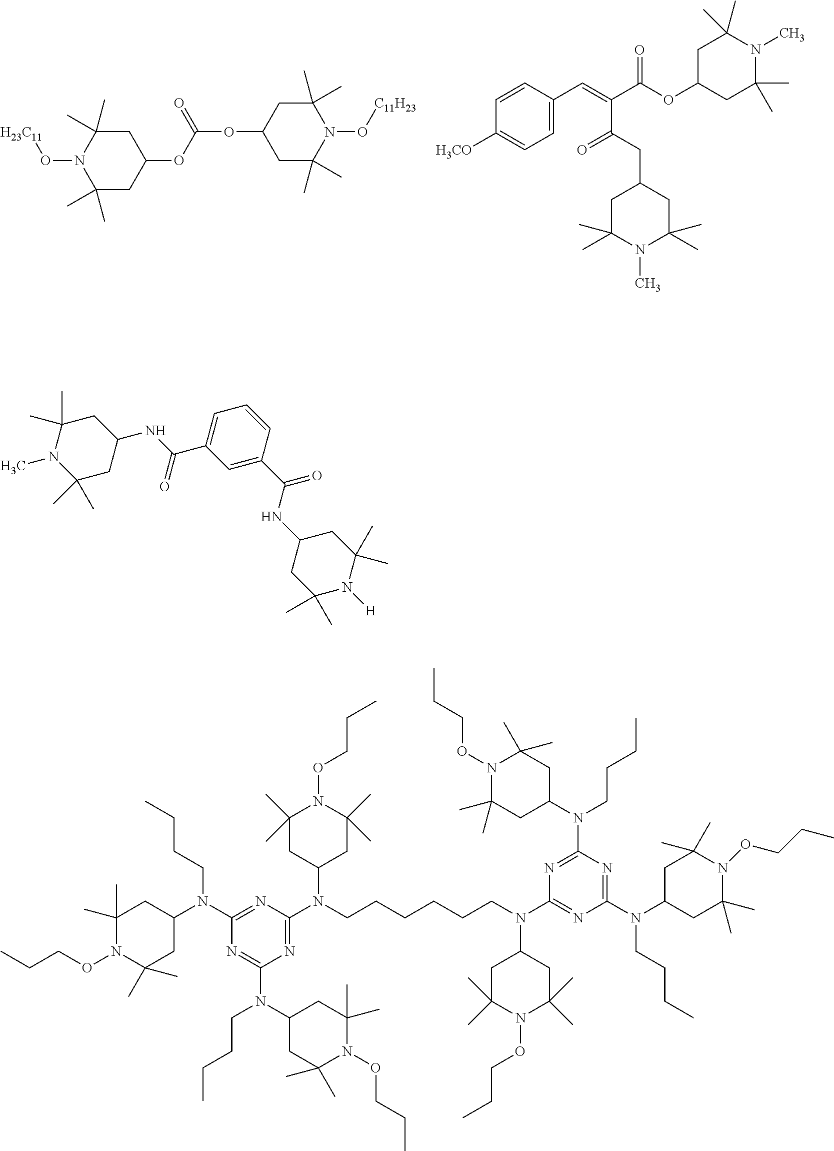

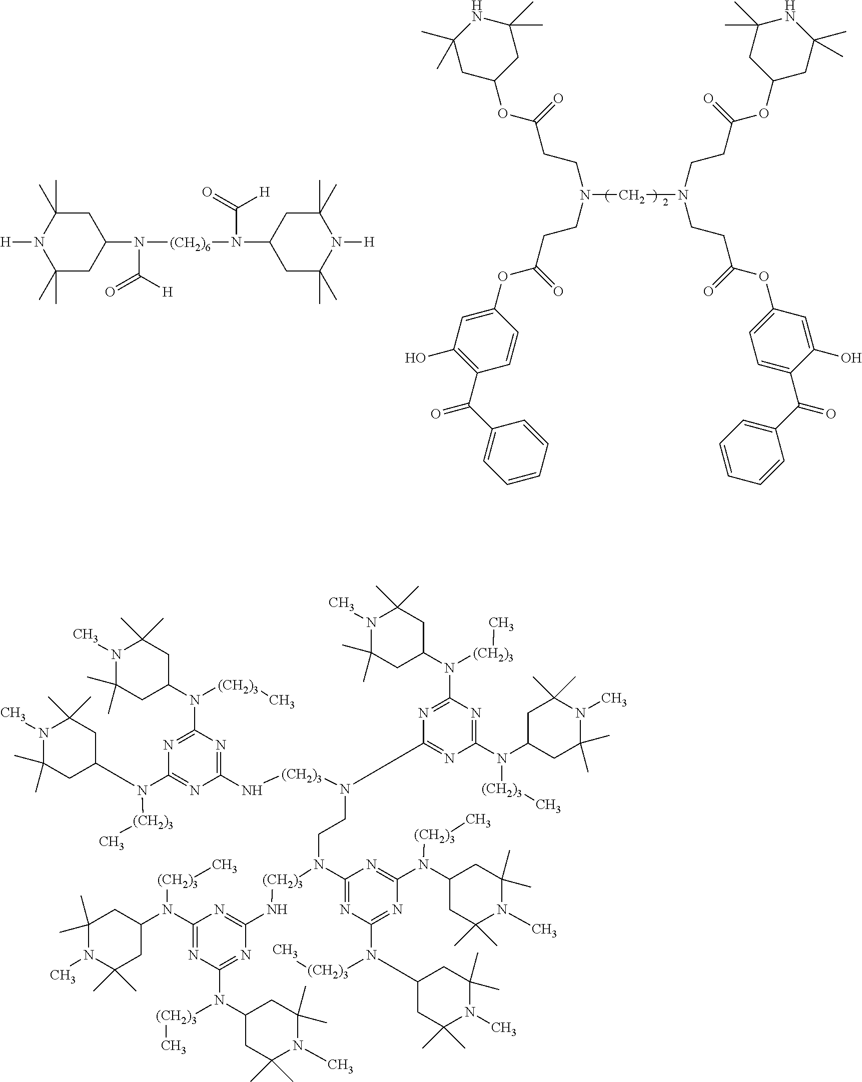

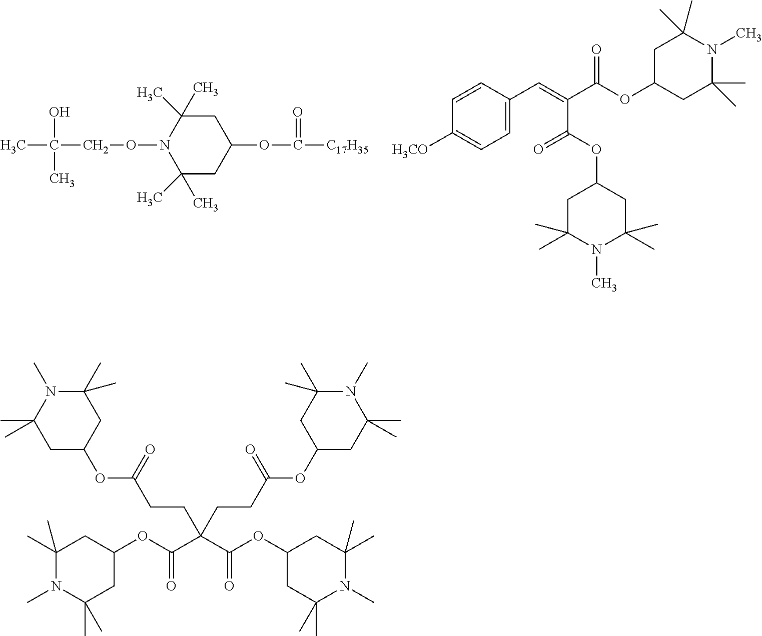

Preferred oligomeric and polymeric hindered amines have the following structures:

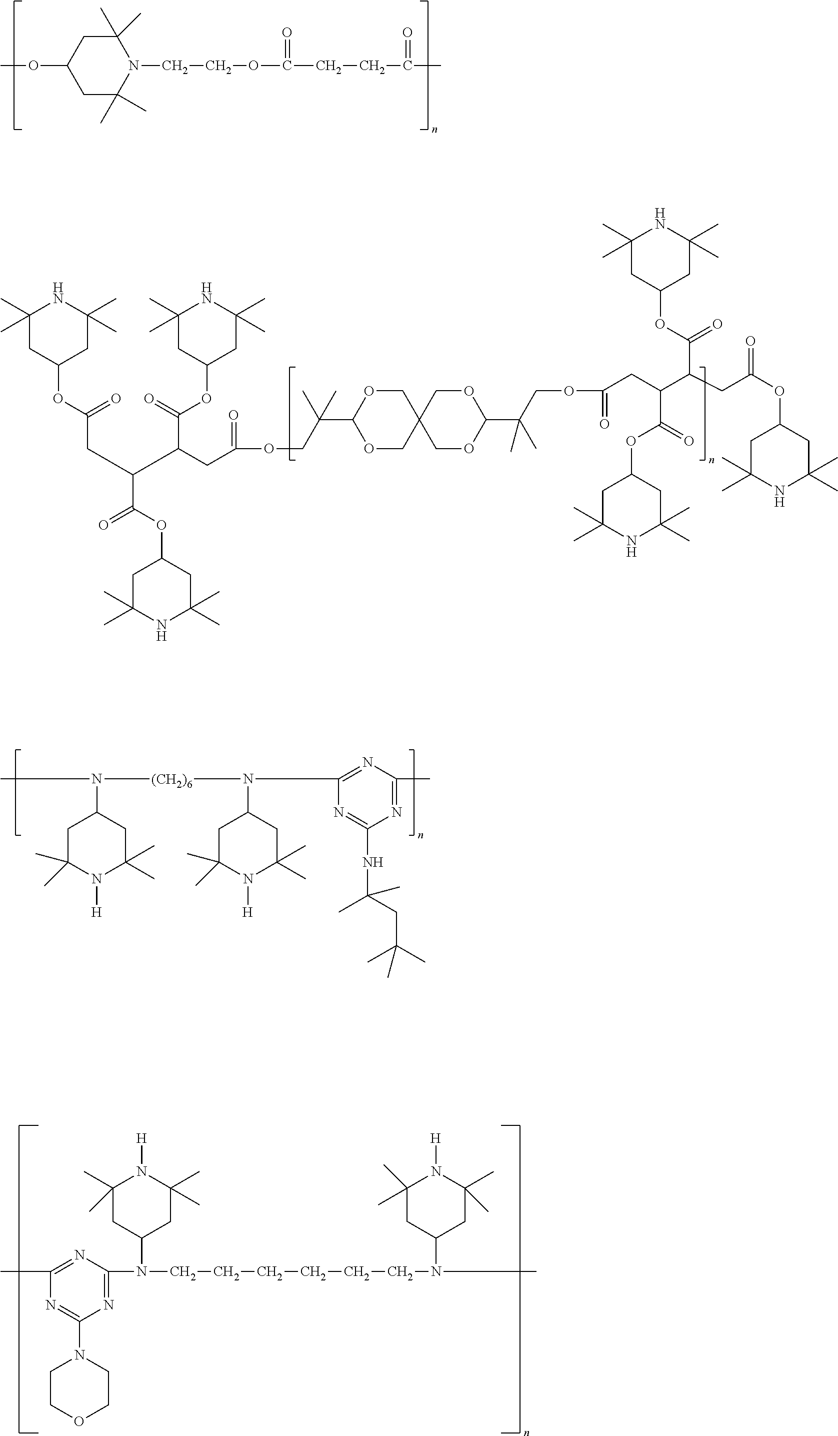

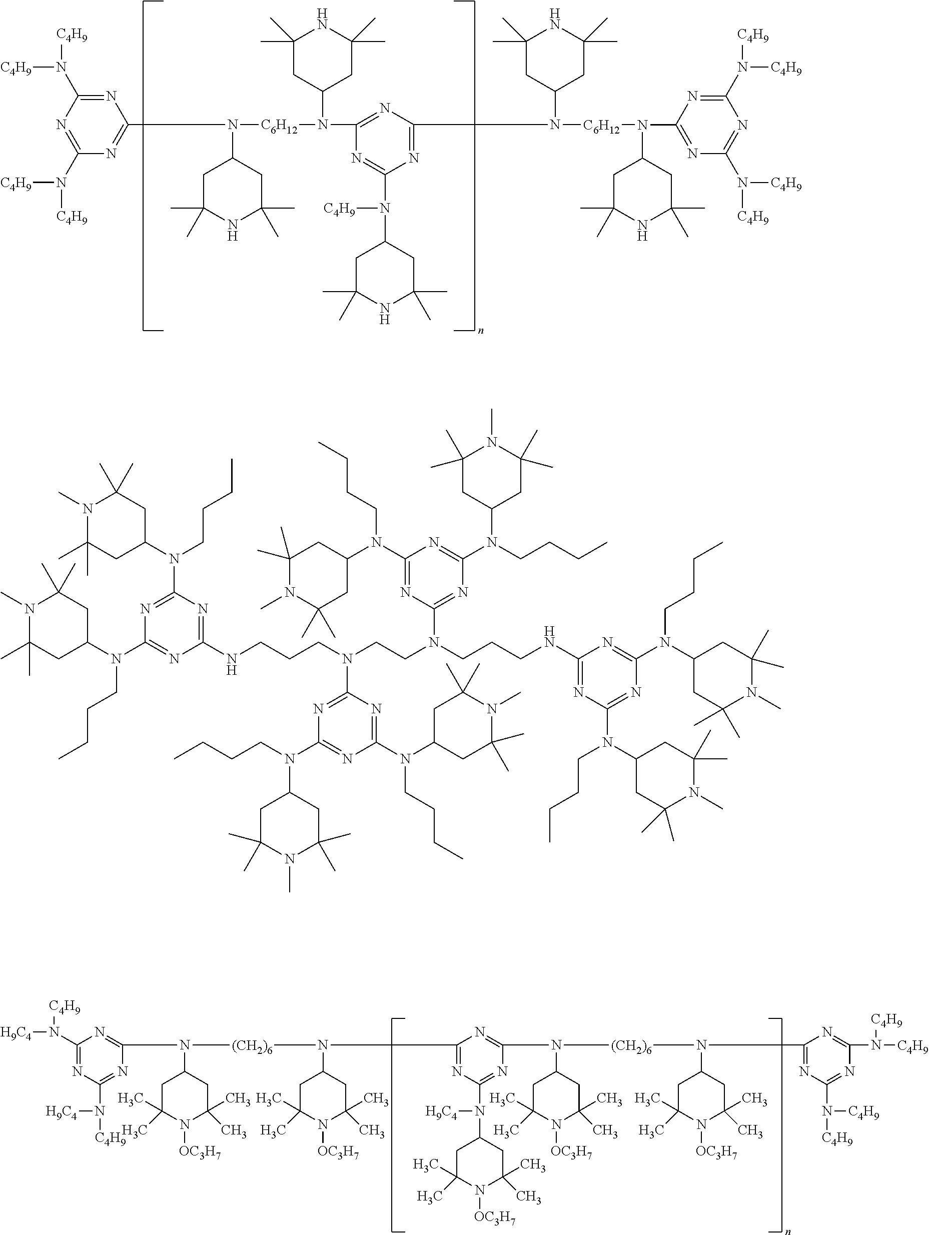

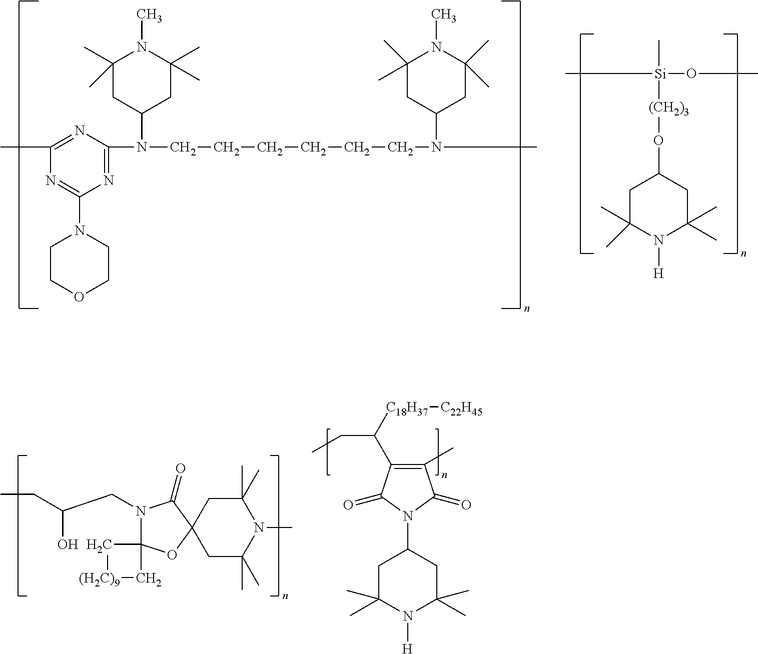

In the above-named compounds, n respectively means 2 to 100, preferably 3 to 20, particularly preferably 3 to 10.

A further suitable light stabilizer is Hostanox NOW (manufacturer: Clariant SE) having the following general structure:

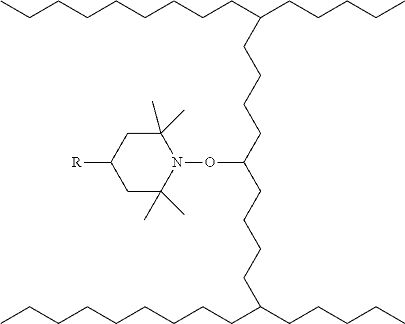

where R is —O—C(O)—C₁₅H₃₁—O—C(O)—C₁₇H₃₅.

Compatibilizers are used, for example, with thermodynamically non-miscible blends or also with recyclate mixtures and comprise structural elements of the respective blend components that are mixed. Suitable compatibilizers for polyolefin mixtures are, for example, olefin block copolymers consisting of ethylene, propylene, and alpha-olefins such as 1-octene. Other compatibilizers, in particular for the compatibilization of polar plastics such as PET or polyamides, and non-polar plastics such as PP or PE polymers are, for example, polypropylene-g-maleic acid anhydride, polyethylene-g-maleic acid anhydride, polypropylene-g-acrylic acid, polyethylene-g-acrylic acid, poly(ethylene-co-maleic acid anhydride), SBS-g-maleic acid anhydride, SEBS-g-maleic acid anhydride, polyethylene-co-methyl acrylate-co-glycidyl acrylate or polyethylene-co-methyl acrylate-co-glycidyl methacrylate.

Suitable dispersion agents are, for example:

polyacrylates, for example, copolymers having long chain side groups, polyacrylate block copolymers, alkylamides: for example, N,N′-1,2-ethanediylbisoctadecanamide sorbitan esters, for example, monostearyl sorbitan esters, titanates and zirconates, reactive copolymers having functional groups, for example, polypropylene-co-acrylic acid, polypropylene-co-maleic anhydride, polyethylene-co-glycidyl methacrylate, polystyrene-alt-maleic anhydride-polysiloxanes: for example, dimethylsilanediol-ethylene oxide copolymer, polyphenylsiloxane copolymer, amphiphilic copolymers: for example, polyethylene block polyethylene oxide, dendrimers, for example, dendrimers comprising hydroxyl groups.

Suitable antinucleating agents are azine dyes, such as e.g. nigrosine.

Suitable flame retardant agents are, in particular
a) inorganic flame retardant agents such as e.g. Al(OH)₃, Mg(OH)₂, AlO(OH), MgCO₃, sheet silicates such as montmorillonite or sepiolite, unmodified or organically modified double salts such as Mg—Al silicates, POSS (polyhedral oligomeric silsesquioxanes) compounds, huntite hydromagnesite or halloysite and Sb₂O₃, Sb₂O₅, MoO₃, zinc stannate, zinc hydroxystannate,
b) flameproofing agents comprising nitrogen such as melamine, melem, melam, melon, melamine derivatives, melamine condensation products or melamine salts, benzoguanamine, polyisocyanurates, allantoin, phosphacenes, in particular melamine cyanurate, melamine phosphate, dimelamine phosphate, melamine pyrophosphate, melamine polyphosphate, melamine metal phosphates such as melamine aluminum phosphate, melamine zinc phosphate, melamine magnesium phosphate, and the corresponding pyrophosphates and polyphosphates, poly-[2,4-(piperazine-1,4-yl)-6-(morpholine-4-yl)-1,3,5-triazine], ammonium polyphosphate, melamine borate, melamine hydrobromide,
c) radical formers, such as alkoxyamines, hydroxylamine esters, azo compounds, sulfene amides, sulfene imides, dicumyl or polycumyl, hydroxyimide and derivatives thereof such as e.g. hydroxyimide esters or hydroxyimide ethers,
d) Flame retardant agents comprising phosphorus such as red phosphorus, phosphates such as resorcin diphosphate, bisphenol-A-diphosphate, and their oligomers, triphenylphosphate, ethylene diamine diphosphate, phosphinates such as hypophosphorous acid and their derivatives such as alkylphosphinate salts, e.g. diethylphosphinate aluminum or diethylphosphinate zinc or aluminum phosphinate, aluminum phosphite, aluminum phosphonate, phosphonate esters, oligomer and polymer derivatives of the methane phosphonic acid, 9,10-dihydro-9-oxa-10-phosphorylphenanthrene-10-oxide (DOPO) and their substituted compounds,
e) halogenated flameproofing agents based on chlorine and bromine, such as e.g. polybrominated diphenyl oxides, such as e.g. decabromodiphenyloxide, tris(3-bromo-2,2-bis (bromomethyl)propyl-phosphate, tris(tribromoneopentyl)phosphate, tetrabromophthalic acid, 1,2-bis(tribromophenoxy)ethane, hexabromocyclododecane, brominated diphenylethane, tris-(2,3-dibrompropyl)isocyanurate, ethylene-bis-(tetrabromophthalimide), tetrabromo-bisphenol A, brominated polystyrene, brominated polybutadiene or polystyrene brominated polybutadiene copolymers, brominated polyphenylene ether, brominated epoxy resin, polypentabromobenzylacrylate, optionally in combination with Sb₂O₃ and/or Sb₂O₅,
f) borates, such as e.g. zinc borate or calcium borate, optionally on a carrier material, such as e.g. silica
g) sulphur-comprising compounds, such as e.g. elemental sulphur, disulfides and polysulfides, thiuram sulfide, dithiocarbamates, mercaptobenzothiazole and sulfenamides,
h) anti-drip agents, such as e.g. polytetrafluoroethylene,
i) silicon-comprising compounds, such as e.g. polyphenyl siloxanes,
j) carbon modifications, such as e.g. carbon nanotubes (CNTs), expandable graphite or graphene,
k) and combinations or mixtures thereof.

Suitable plasticizers are, for example, phthalic acid esters, adipic acid esters, esters of citric acid, ester of 1,2-cyclohexane dicarboxylic acid, trimellitic acid esters, isorobide esters, phosphate esters, epoxides such as epoxidized soy bean oil, or aliphatic polyesters.

Suitable mold lubricants and processing aids are, for example, polyethylene waxes, polypropylene waxes, salts of fatty acids such as calcium stearate, zinc stearate, or salts of montane waxes, amide waxes such as erucic acid amide or oleic acid amides, fluoropolymers, silicones, or neoalkoxytitanates and zirconates.

Suitable pigments can be of an inorganic or organic nature. Inorganic pigments are, for example, titanium dioxide, zinc oxide, zinc sulfide, iron oxide, ultramarine, black carbon; organic pigments are, for example, anthraquinones, anthanthrones, benzimidazolones, chinacridones, diketoptyrrolopyrrols, dioxazines, inanthrones, isoindolines, azo compounds, perylenes, phthalocyanines or pyranthrones. Further suitable pigments include effect pigments on a metal base or pearl gloss pigments on a metal oxide base.

Suitable optical brighteners are, for example, bis-beznzoxazoles, phenylcumarines, or bis(styryl)biphenyls and in particular optical brighteners of the formulas:

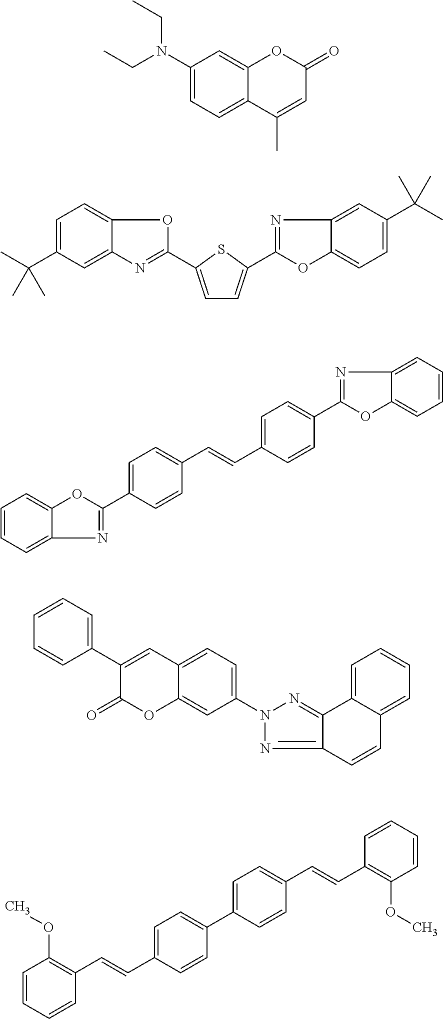

Suitable filler deactivators are, for example, polysiloxanes, polyacrylates, in particular block copolymers such as polymethacrylic acid polyalkyene oxide or polyglycidyl(meth)acrylates and their copolymers, e.g. with sytrene and epoxides of e.g. the following structures:

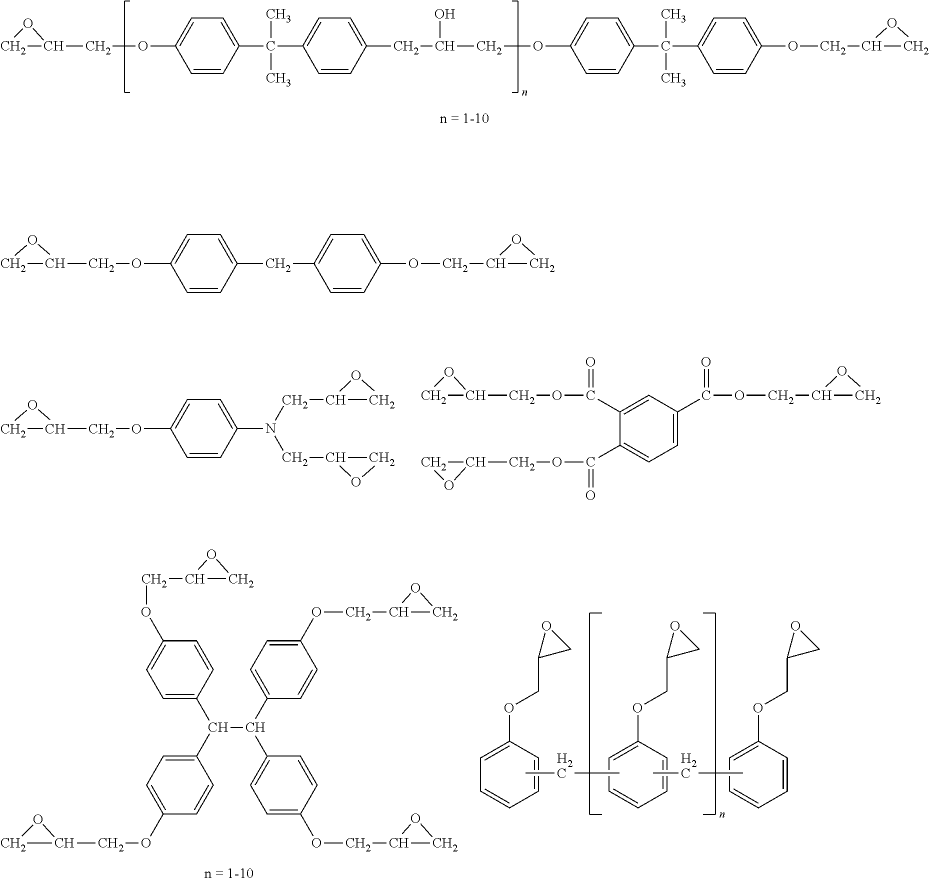

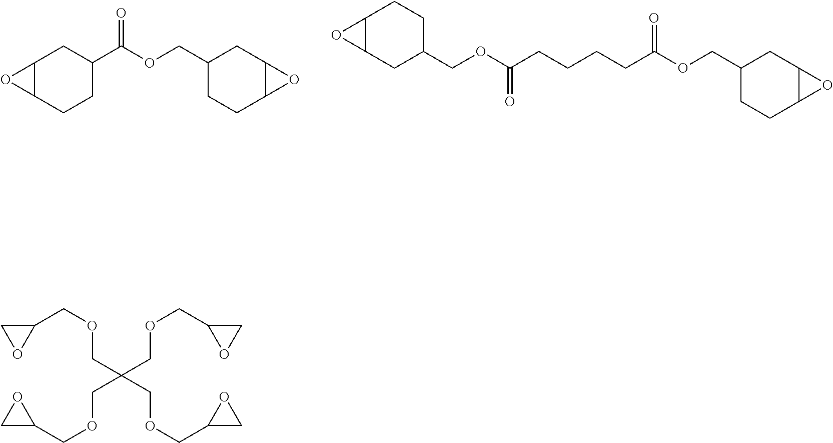 [SMILES: O=C(OCC1CCC2OC2C1)C1CCC2OC2C1 ; O=C(CCCCC(=O)OCC1CCC2OC2C1)OCC1CCC2OC2C1 ; C(OCC(COCC1CO1)(COCC1CO1)COCC1CO1)C1CO1]

Suitable antistatic agents are, for example, ethoxylated alkylamines, fatty acid esters, alkylsulfonates, and polymers such as polyetheramides.

Suitable antiozonants are the above-named amines such as N,N′-di-isopropyl-p-phenylene diamine, N,N′-di-sec-butyl-p-phenylene diamine, N,N′-bis(1,4-dimethylpentyl)-p-phenylene diamine, N,N′-dicyclohexyl-p-phenylene diamine, N-isopropyl-N′-phenyl-p-phenylene diamine, N-(1,3-dimethylbutyl)-N′-phenyl-p-phenylene diamine, N-(1-methylheptyl)-N′-phenyl-p-phenylene diamine, N-cyclohexyl-N′-phenyl-p-phenylene diamine.

Suitable nucleation agents are, talcum, alkali, or alkaline earth salts of mono- and polyfunctional carboxylic acids such as benzoic acid, succinic acid, adipic acid, e.g. sodium benzoate, zinc glycerolate, alumini umhydroxy-bis(4-tert-butyl)benzoate, 2,2′-methylene-bis-(4,6-di-tert-butylphenyl) phosphate, and trisamides and diamides such as trimesic acid tricyclohexylamide, trimesic acid tri(4-methylcyclohexylamide), trimesic acid tri(tert-butylamide), N,N′,N″-1,3,5 benzoltriyltris(2,2-dimethyl-propanamide) or 2,6-naphthalene dicarboxylic acid cyclohexylamide.

Suitable additives for the linear molecular weight structure of polycondensation polymers (chain extenders) are diepoxides, bis-oxazonlines, bis-oxazolones, bis-oxazines, diisoscyanates, dianhydrides, bis-acyllactams, bis-maleimides, dicyanates, carbodiimides.

Further suitable chain extenders are polymer compounds such as e.g. polystyrene polyacrylate polyglycidyl(meth)acrylate copolymers, polystyrene maleic acid anhydride copolymers, and polyethylene maleic acid anhydride copolymers.

Suitable additives for increasing the electrical conductivity are, for example, the antistatic agents mentioned, carbon black and carbon compounds like carbon nanotubes and graphene, metal powder, such as e.g. copper powder, and conductive polymers, such as e.g. polypyrroles, polyanilines and polythiophenes. Suitable additives to increase thermal conductivity are, for example, aluminum nitrides and boron nitrides.

Suitable infrared-active additives are, for example, aluminum silicates or dyestuffs such as phthalocyanines or anthraquinones.

Suitable demolding agents are, for example, silicones, soaps, and waxes, such as montan waxes.

The incorporation of the additives described above and optionally of the additional additives into the plastic takes place by typical processing methods, with the polymers being melted and being mixed with the additive composition in accordance with the invention and the optionally further additives, preferably by mixers, kneaders, or extruders. Extruders such as single-screw extruders, twin screw extruders, planetary gear extruders, ring extruders, and co-kneaders that are preferably equipped with a vacuum degassing are preferred as processing machines. The processing can take place here under air or, optionally, under inert gas conditions.

The additive compositions in accordance with the invention can furthermore be comprised, prepared and incorporated in a polymer in the form of so-called master batches or concentrates that, for example, include 10-90% of the compositions in accordance with the invention.

The present invention moreover relates to a stabilizer composition for the stabilization of halogen-free thermoplastic plastic recyclates, in particular against oxidative, thermal, and/or actinic degradation, consisting of at least one sulfite and/or at least one thiosulfate in combination with at least one primary antioxidant.

Provision is made in a preferred embodiment that the totality of the at least one sulfite and/or thiosulfate and the totality of the at least one primary antioxidant are used in a weight ratio of 1:99 to 99:1, preferably 20:80 to 80:20, further preferably from 30:70 to 70:30, particularly preferably from 40:60 to 60:40.

The additive compositions in accordance with the invention can furthermore be comprised, prepared and incorporated in a polymer in the form of so-called master batches or concentrates that, for example, include 10-90% of the compositions in accordance with the invention.

To this extent, the present invention equally relates to a masterbatch or concentrate comprising 10 to 90 wt % of a stabilizer composition in accordance with one of the two preceding claims and 90 to 10 wt % of a halogen-free thermoplastic or of a plastic recyclate.

The present invention furthermore relates to a plastic composition comprising or consisting of
A) a stabilizer composition in accordance with the invention and
B) a halogen-free thermoplastic plastic recyclate.

In accordance with a preferred embodiment, the plastic composition in accordance with the invention has the following composition:
A) 0.01 to 10.00 wt. %, preferably 0.02 to 5.00 wt. %, particularly preferably 0.05 to 2.00 wt % of the stabilizer composition;
B) 85.00 to 99.98 wt %, preferably 96 to 99.90 wt %, of at least one halogen-free thermoplastic plastic recyclate; and
C) 0.01 to 5.00 wt %, preferably 0.02 to 2.00 wt %, of at least one additive.

The plastic composition can preferably comprise at least one additive, with the at least one additive preferably being selected from the group consisting of secondary antioxidants, secondary antioxidants excluding phosphite and phosphonites, UV absorbers, light stabilizers, metal deactivators, filler deactivators, antiozonants, nucleation agents, anti-nucleation agents, toughening agents, mold lubricants, rheological modifiers, thixotropic agents, chain extenders, processing aids, demolding aids, flame retardants, pigments, dyes, optical brighteners, antimicrobial active agents, antistatic agents, slip agents, anti-blocking agents, coupling agents, crosslinking agents, anti-cross-linking agents, hydrophilization agents, hydrophobing agents, bonding agents, dispersing agents, compatibilizers, oxygen scavengers, acid scavengers, expanding agents, degradation additives, defoaming agents, odor scavengers, marking agents, anti-fogging agents, fillers, reinforcement materials, and mixtures thereof.

A further embodiment of the plastic composition provides that up to 80 wt %, preferably 0.1 to 60 wt %, particularly preferably 1 to 50 wt %, of at least one plasticizer, filler, reinforcement material, polyol costabilizers, and/or compatibilizers is comprised with respect to 100 wt % of components (A) to (C).

Preferred additives are in particular acid scavengers, light stabilizers or fillers, reinforcement materials, polyol costabilizers, and/or compatibilizers.

In this respect, suitable acid scavengers are selected from the group consisting of salts of monovalent, bivalent, trivalent, or tetravalent metals, preferably alkali metals, alkaline earth metals, aluminum or zinc, in particular formed with fatty acids such as calcium stearate, magnesium stearate, zinc stearate, aluminum stearate, calcium laurate, calcium behenate, calcium lactate, calcium stearoyl-2-lactate. Further classes of suitable acid scavengers are hydrotalcites, in particular synthetic hydrotalcites on the basis of aluminum, magnesium and zinc, hydrocalumites, zeolites, alkaline earth metals, in particular calcium oxide and magnesium oxide and zinc oxide, alkaline earth carbonates, in particular calcium carbonate, magnesium carbonate and dolomite, and hydroxides, in particular brucite (magnesium hydroxide);
light stabilizers selected from the group consisting of hindered amines; and
fillers and/or reinforcement materials selected from the group consisting of calcium carbonates, silicates, talcum, mica, kaolins, metal oxides, metal hydroxides, black carbon, graphite, wood flour, fibers of natural products such as cellulose; glass fibers, carbon fibers, polyamide fibers, and other synthetic polymer fibers, hydrotalcites, zeolites, and/or phyllosilicates such as montmorillonite, bentonite, beidelite, mica, hectorites, saponite, vermiculite, ledikite, magadite, illite, kaolinite, wollastonite, attapulgite.

The present invention moreover relates to a molding compound or a molded part that can be produced from a plastic composition in accordance with the invention described in the above.

The molding compound or molded part can in particular be in the form of films; packaging, e.g. for foodstuffs or cosmetic products, detergents, cosmetics, or adhesives; hollow bodies, in particular bottles, pouches, screw lid jars, storage and transport containers such as boxes, crates, barrels, buckets, parts of automobiles, railroads, aircraft, ships, and machines such as bumpers, trim, dashboard parts and functional parts, upholstery; construction applications such as sections, construction films, roof sheeting, gable ducts, sidings, noise-insulating walls, drainage gutters, sections such as window and door sections, molded boards, floor coverings, pallets;
road and agricultural applications such as rod bases, poles, barriers, traffic cones, transport containers such as barrels, buckets, carrier bags, sacks, and pallets, foams, belts, injection molded parts, fibers, and other extrudates;
automobile parts and parts for the electrical and electronic industries such as housing parts, furniture, domestic goods, sports and leisure products in agricultural applications, e.g. for the manufacture of agricultural films such as geotextiles, films for glasshouses, mulch, or tunnels, or perforated films.

The present invention moreover relates to a method of the oxidative, thermal, and/or actinic stabilization of a halogen-free thermoplastic plastic recyclate, in particular against oxidative, thermal, and/or actinic degradation by addition, additiviation, or integration of at least one stabilization composition in accordance with the invention to or into the halogen-free thermoplastic plastic recyclate.

The method in accordance with the invention is in particular characterized in that the thermal stabilization takes place during the thermal processing of the halogen-free thermoplastic plastic recyclate, with the thermal processing in particular taking place under aprotic conditions.

The present invention furthermore relates to the use of the composition in accordance with the invention for the manufacture of
films;
packagings, for example for foodstuffs or cosmetic products, detergents, cosmetics or adhesives;
hollow bodies, in particular bottles, bags, screw-top cans; storage and transport containers, e.g. boxes, crates, barrels, buckets,
parts of automobiles, railroads, aircraft, ships, and machines such as bumpers, trim, dashboard parts and functional parts, upholstery;
construction applications such as sections, construction films, roof sheeting, cable ducts, sidings, noise-insulating walls, drainage gutters, sections such as window and door sections, molded boards, floor coverings, pallets;
road and agricultural construction applications such as rod bases, poles, barriers, traffic cones,
transport containers such as barrels, buckets, carrier bags, sacks, and pallets,
transport containers such as barrels, buckets, carrier bags, sacks, and pallets, foams, belts, injection molded parts, fibers, and other extrudates;
automobile parts and parts for the electrical and electronic industries such as housing parts, furniture, domestic goods, sports and leisure products;
in agricultural applications, e.g. for the manufacture of agricultural films such as geotextiles, films for glasshouses, mulch, or tunnels, or perforated films.

The present invention will be described in more detail with reference to the following example without restricting the invention to the specific parameters.

### EMBODIMENTS

A post-consumer polypropylene recyclate from accumulator box ground stock (supplier: BSB Braubach) together with the additives given in the Table was conveyed in a circle in the melt at 210° C. in a twin screw microextruder (5 cc, manufacturer DSM) in continuous mode at 200 revolutions a minute for 30 minutes to check the effect of the stabilizer composition in accordance with the invention. The force absorption is measured after 30 minutes. The force is a measure for the toughness of the melt and thus for the molecular weight of the polypropylene recyclate used. The higher the remaining force, the smaller the degradation of the polymer. The respective average of 2 experiments is given.

| | | Residual force after |
|---|---|---|
| | Post-stabilization | 30 minutes [%] |
| Comparative | Without additive | 21 |
| example 1 | | |
| Comparison | 0.2% sodium sulfite | 27 |
| example 2 | | |
| Comparison | 0.1% AO-1 + 0.1% P-1 | 44 |
| example 3 | | |
| (Prior Art) | | |
| Example 1 in | 0.1% sodium sulfite + | 51 |
| accordance with | 0.1% AO-1 | |
| the invention | | |
| Example 2 in | 0.25% sodium sulfite + | 65 |
| accordance with | 0.25% AO-1 | |
| the invention | | |

AO-1: Pentaerythritol-tetrakis [3-(3,5-di-tert-butyl-4-hydroxyphenyl)propionate
P-1: Tris-(2,4--di-tert-butylphenyl)phosphite

The synergistic combination in accordance with the invention has proven superior in the present test to the synthetic commercial synergistic combinations of AO-1 and P-1 (Comparison example 3) since there is a smaller degradation of the polymer over the experiment time.

In a further series of experiments, an HDPE recyclate from reusable material collections was extruded five times by means of multiple extrusion on a 16 mm twin screw extruder at 255° C. maximum temperature and 200 revolutions per minute and the respective resulting MVR was determined after the 1st, 3rd, and 5th extrusion.

Post-stabilization of HDPE recyclate

| | | MVR | MVR after 1st | MVR after 3rd | MVR after 5th |
|---|---|---|---|---|---|
| | | prior to | extrusion | extrusion | extrusion |
| # | Additive | extrusion | Extrusion | Extrusion | Extrusion |
| Comparison example 4 | 0.1% calcium stearate | 7.03 | 6.45 | 5.66 | 4.40 |
| Comparison example 5 | 0.05% AO-1 + 0.05% P-1 | 7.03 | 6.74 | 6.59 | 6.04 |
| (Prior Art) | 0.1% calcium stearate | | | | |
| Example 3 in accordance | 0.0125% vitamin E + | 7.03 | 6.74 | 6.54 | 6.03 |
| with the invention | 0.0125% sodium sulfite | | | | |
| | 0.1% calcium stearate | | | | |
| Example 4 in accordance | 0.025% vitamin E + | 7.03 | 6.91 | 6.92 | 6.86 |
| with the invention | 0.025% sodium sulfite | | | | |
| | 0.1% calcium stearate | | | | |

The unstabilized HDPE recyclate shows a clear reduction in the MVR value, i.e. a molecular weight increase as a result of branching and/or interlocking (Comparison example 4).

Standard stabilizers, i.e. AO-1 in combination with P-1 result, as expected, in an improvement, i.e. a smaller reduction of the MVR value; however; no constant value is reached with the used amount. In contrast, Example 4 in accordance with the invention shows an excellent stabilization effect with considerably smaller concentrations up to an MVR value almost unchanged over 5 extrusion steps (Example 4 in accordance with the invention).

1-22. (canceled)

23. A method of stabilizing a halogen-free thermoplastic plastic recyclate against degradation, the method comprising combining the recyclate with at least one stabilizer composition comprising at least one sulfite and/or at least one thiosulfate in combination with at least one primary antioxidant.

24. The method according to claim 23, wherein the degradation is against oxidative and/or actinic degradation.

25. The method according to claim 23, wherein the at least one sulfite is an inorganic sulfite, an inorganic disulfite, or an inorganic hydrogen sulfite wherein the inorganic part is a monovalent, bivalent, trivalent, or tetravalent metal and/or the at least one thiosulfate is a monovalent, bivalent, trivalent, or tetravalent metal thiosulfate.

26. The method according to claim 25, wherein the monovalent, bivalent, trivalent, or tetravalent metal is an alkali metal, an alkaline earth metal, aluminum, and/or zinc.

27. The method according to claim 26, wherein the sulfite is selected from the group consisting of sodium sulfite, potassium sulfite, lithium sulfite, calcium sulfite, magnesium sulfite, aluminum sulfite, zinc sulfite, or an organic sulfite and mixtures and combinations thereof, and/or
the at least one thiosulfate is a monovalent, bivalent, trivalent, or tetravalent metal thiosulfate wherein the metal is an alkaline metal, an alkaline earth metal, aluminum, and/or zinc.

28. The method according to claim 25, wherein the thiosulfate or the sulfite is free of water of crystallization.

29. The method of claim 23, wherein the at least one primary antioxidant is selected from the group consisting of H-donors, scavengers, phenolic antioxidants, partially or fully aromatic amines, hydroxylamines, N-oxides or nitrones, and lactones.

30. The method according to claim 29, wherein the antioxidants are selected from:
a) alkylated monophenols selected from the group consisting of 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutyl phenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, and 2,6-di-tert-butyl-4-methoxymethylphenol,
linear or branched nonylphenols selected from the group consisting of 2,6-dinonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof;
alkylthio methylphenols selected from the group consisting of 2,4-dioctylthiomethyl-6-tert-butylphenol, 2,4-dioctylthiomethyl-6-methylphenol, 2,4-dioctylthiomethyl-6-ethylphenol, and 2,6-didodecylthiomethyl-4-nonylphenol;
hydroquinones and alkylated hydroquinones selected from the group consisting of 2,6-di-tert-butyl-4-methoxyphenol, 2,5-di-tert-butylhydroquinone, 2,5-di-tert-amyl hydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, and bis(3,5-di-tert-butyl-4-hydroxylphenyl)adipate;
tocopherols selected from the group consisting of as α-, β-, γ-, δ-tocopherol and mixtures thereof (vitamin E);
antioxidants selected from the group consisting of tocotrienols, tocomonoenols, ubichinols, hydroxytyrosol, flavanoids and flavaonols, wherein the flavanoids or flavanols are selected from the group consisting of chrysin, quercitin, hesperidin, neohe-speridin, naningin, morin, kaempferol, fisein, datiscetin, luteolin, apigenin, taxifolin, isoflavones selected from the group consisting of genistein, genistin, daidzein, daidzin, formononetin, anthocyanes selected from the group consisting of delphinidin and malvidin, curcumin, carnosoic acid, carnosol, rosemarinic acid, tannin and resveratrol, and carotenoids having alcoholic groups selected from the group consisting of beta-cryptoxanthin, lutein, zeaxanthin, and astaxanthin;
hydroxylated thiodiphenylethers selected from the group consisting of 2,2′-thiobis(6-tert-butyl-4-methylphenol), 2,2′-thiobis(4-Phenol), 4,4′-thiobis(6-tert-butyl-3-methylphenol), 4,4′-thiobis(6-tert-butyl-2-methylphenol), 4,4′-thiobis(3,6-di-sec-amyl phenol), and 4,4′-bis(2,6-dimethyl-4-hydroxyphenyl)disulfide;
alkylide bisphenols selected from the group consisting of 2,2′methylenebis(6-tert-butyl-4-methylphenol), 2,2′-methylenebis(6-tert-butyl-4-ethylphenol), 2,2′-Methylenebis[4-methyl-6-(α-methylcyclohexyl)phenol], 2,2′-methylenebis(4-methyl-6-cyclhexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutyl phenol), 2,2′-methylenebis[6-(α-methylbenzyl)-4-nonylphenol], 2,2′-methylenebis[6-(α,α-dimethyl benzyl)-4-nonylphenol], 4,4′-methylenebis(2,6-di-tert-butylphenol, 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycole-bis[3,3-bis(3′-tert-butyl-4′-hydroxyphenyl)butyrate], bis(3-tert-butyl-4-hydroxy-5-methylphenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis-(5-tert-butyl-4-hydroxy-2-methylphenyl)-4-n-dodecylmercaptobutane, 1,1,5,5-tetra(5-tert-butyl-4-hydroxy-2-methylphenyl)pentane;
O-, N- and S-benzyl compounds such as 3,5,3′,5′-tetra-tert-butyl-4,4′-dihydroxydibenzylether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, and isooctyl-3,5-di-tert-butyl-4-hydroxybenzylmercaptoacetate;
hydroxy benzylated malonates selected from the group consisting of dioctadecyl-2,2-bis(3,5-di-tert-butyl-2-hydroxybenzyl)malonate, dioctadecyl-2-(3-tert-butyl-4-hydroxy-5-methylbenzyl)malonate, didodecylmercaptoethyl-2,2-bis(3,5-di-tert-butyl-4-hydroxybenzyl)malonate, and bis[4-(1,1,3,3-tetramethylbutyl)phenyl]-2,2-bis(3,5-di-tert-butyl-4-hydroxybenzyl)malonate;
aromatic hydroxybenzyl compounds selected from the group consisting of 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, and 2,4,6-tris(3,5-di-tert-butyl-4-hydroxybenzyl)phenol;
triazine compounds selected from the group consisting of 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxy phenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxphenylethyl)-1,3,5-triazine, 1,3,5-tris(3,5-di-tert-butyl-4-hydroyphenylpropionyl)hexahydro-1,3,5-triazine, 1,3,5-tris(3,5-dicyclohexyl-4-hydroxybenzyl)isocyanurate;
benzyl phosphonates selected from the group consisting of dimethyl-2,5-di-tert-butyl-4-hydroxybenzyl phosphonate, diethyl-3,5-di-tert-butyl-4-hydroxybenzyl phosphonate, dioctadecyl-3,5-di-tert-butyl-4-hydroxybenzyl phosphonate, dioctadecyl-5-tert-butyl-4-hydroxy-3-methylbenzyl phosphonate, a calcium salt of the monoethylester of the 3,5-di-tert-butyl-4-hydroxybenzyl phosphonic acid;
acylaminophenols selected from the group consisting of 4-hydroxylauranilide, 4-hydroxystearanilide, octyl-N-(3,5-di-tert-butyl-4-hydroxyphenyl)carbamate;
esters of the β-(3,5-Di-tert-butyl-4-hydroxyphenyl)propionic acid with monovalent or polyvalent alcohols selected from the group consisting of methanol, ethanol, n-octanol, i-octanol, octadecanoyl, 1,6-hexanediol, 1,9-nonanediol, ethylene glycol, 1,2-propanediol, neopentyl glycol, thiodiethylene glycole, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethyl hexanediol, trimethylolpropane, and 4-hydroxymethyl-1-phospha-2,6,7-trioxabicyclo[2.2.2]octane;
esters of the β-(5-tert-butyl-4-hydroxy-3-methylphenyl)propionic acid with monovalent or polyvalent alcohols selected from the group consisting of ethanol, ethanol, n-octanol, i-octanol, octadecanol, 1,6-hexanediol, 1,9-nonanediol, ethylene glycol, 1,2-propanediol, neopentyl glycol, thio diethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, tri-methyl hexanediol, trimethylolpropane, 4-hydroxymethyl-1-phospha-2,6,7-trioxabicyclo[2.2.2]octane, and 3,9-bis[2-{β-(3-tert-butyl-4-hydroxy-5-methylphenyl)propionyloxy}-1,1-dimethylethyl]-2,4,8,10-tetraoxaspiro[5.5]undecane;
esters of the β-(3,5-dicyclohexyl-4-hydroxyphenyl)propionic acid with monovalent or polyvalent alcohols selected from the group consisting of methanol, ethanol, octanol, octadecanoyl, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl) ID, 3-thiaundecanol, 3-thiapentadecanol, trimethyl hexanediol, trimethylolpropane, and 4-hydroxymethyl-1-phospha-2,6,7-trioxabicyclo[2.2.2]octane;
esters of the (3,5-di-tert-butyl-4-hydroxyphenyl acetic acid with monovalent or polyvalent alcohols selected from the group consisting of methanol, ethanol, octanol, octadecanol, 1,6-hexanediol, 1,9-nonanediol, ethylene glycol, 1,2-propanediol, neopentyl glycol, thio diethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethyl hexanediol, trimethylolpropane, and 4-hydroxymethyl-1-phospha-2,6,7-trioxabicyclo[2.2.2]octane;
amides of the 0-(3,5-di-tert-butyl-4-hydroxyphenyl)propionic acid selected from the group consisting of N,N′-bis(3,5-di-tert-butyl-4-hydroxyphenylpropionyl)hexamethylene diamide, N,N′-bis(3,5-di-tert-butyl-4-hydroxyphenylpropionyl)hexamethylene diamide, N,N′-bis(3,5-di-tert-butyl-4-hydroxyphenylpropionyl)hexamethylene diamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide, and ascorbic acid (vitamin C); or
b) aminic antioxidants selected from the group consisting of N,N′-di-isopropyl-p-phenylene diamine, N,N′-di-sec-butyl-p-phenylene diamine, N,N′-bis(1,4-dimethylpentyl)-p-phenylene diamine, N,N′-bis(1-ethyl-3-methyl pentyl)-p-phenylene diamine, N,N′-bis(1-methylheptyl)-p-phenylene diamine, N,N′-dicyclohexyl-p-phenylene diamine, N,N′-diphenyl-p-phenylene diamine, N,N′-bis(2-naphthyl)-p-phenylene diamine, N-isopropyl-N′-phenyl-p-phenylene diamine, N-(1,3-dimethylbutyl)-N′-phenyl-p-phenylene-diamine, N-(1-methylheptyl)-N′-phenyl-p-phenylene diamine, N-cyclohexyl-N′-phenyl-p-phenylene diamine, 4-(p-toluolsulfamoyl)diphenylamine, N,N′-dimethyl-N,N′-di-sec-butyl-p-phenylene diamine, diphenylamine, N-allyl diphenylamine, 4-isopropoxydiphenylamine, N-phenyl-1-naphthylamine, N-(4-tert-octyl phenyl)-1-naphthylamine, N-phenyl-2-naphthylamine, octylated diphenylamine, p, p′-di-tert-octyl diphenylamine, 4-n-butyl aminophenol, 4-butyryl aminophenol, 4-nonanoyl aminophenol, 4-dodecanoyl aminophenol, 4-octadecanoyl amino-phenol, bis(4-methoxyphenyl)amine, 2,6-di-tert-butyl-4-dimethylaminomethyl-phenol, 2,4′-diamino diphenylmethane, 4,4′-diamino diphenylmethane, N,N,N′,N′-tetra-methyl-4,4′-diamino diphenylmethane, 1,2-bis[(2-methyl-phenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of monoalkylated and dialkylated tert-butyl/tert-octyldiphenylamines, a mixture of monoalkylated and dialkylated nonyldiphenylamines, a mixture of monoalkylated and dialkylated dodecyldiphenylamines, a mixture of monoalkylated and dialkylated isopropyl/isohexyl-diphenylamines, a mixture of monoalkylated and dialkylated tert-butyldiphenylamines, 2,3-dihydro-3,3-dimethyl-4H-1,4-benzothiazine, phenothiazine, a mixture of monoalkylated and dialkylated tert-butyl/tert-octylphenothiazines, a mixture of monoalkylated and dialkylated tert-octylphenothiazines, N-llylphenothiazine, N,N,N′,N′-tetraphenyl-1,4-diamino but-2-ene, and mixtures or combinations thereof;
c) hydroxylamines or N-oxides (nitrones) selected from the group consisting of N,N-dialkylhydroxylamines, N,N-dibenzyl hydroxyl-amine, N,N-dilaurylhydroxylamine, N,N-distearylhydroxylamine, N-benzyl-α-phenylnitrone, N-octadecyl-α-hexadecylnitrone, and Genox EP (marketed by SI Group) in accordance with the formula: 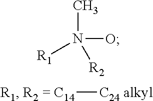
d) lactones selected from the group consisting of benzofuranones and indolinones which in turn are selected from the group consisting of 3-(4-(2-acetoxyethoxy)phenyl]-5,7-di-tert-butyl-benzofuran-2-one, 5,7-di-tert-butyl-3-[4-(2-stearoyloxyethoxy)phenyl]benzofuran-2-one, 3,3′-bis[5,7-di-tert-butyl-3-(4-(2-hydroxy ethoxy]phenyl)benzo-furan-2-one), 5,7-di-tert-butyl-3-(4-ethoxy phenyl)benzofuran-2-one, 3-(4-acetoxy-3,5-dimethylphenyl)-5,7-di-tert-butyl-benzofuran-2-one, β-(3,5-dimethyl-4-pivaloyloxyphenyl)-5,7-di-tert-butyl-benzofuran-2-one, β-(3,4-dimethylphenyl)-5,7-di-tert-butyl-benzofuran-2-one, 3-(2,3-dimethylphenyl)-5,7-di-tert-butyl-benzofuran-2-one, lactones that additionally contain a phosphite group, and compounds of the following formulas: 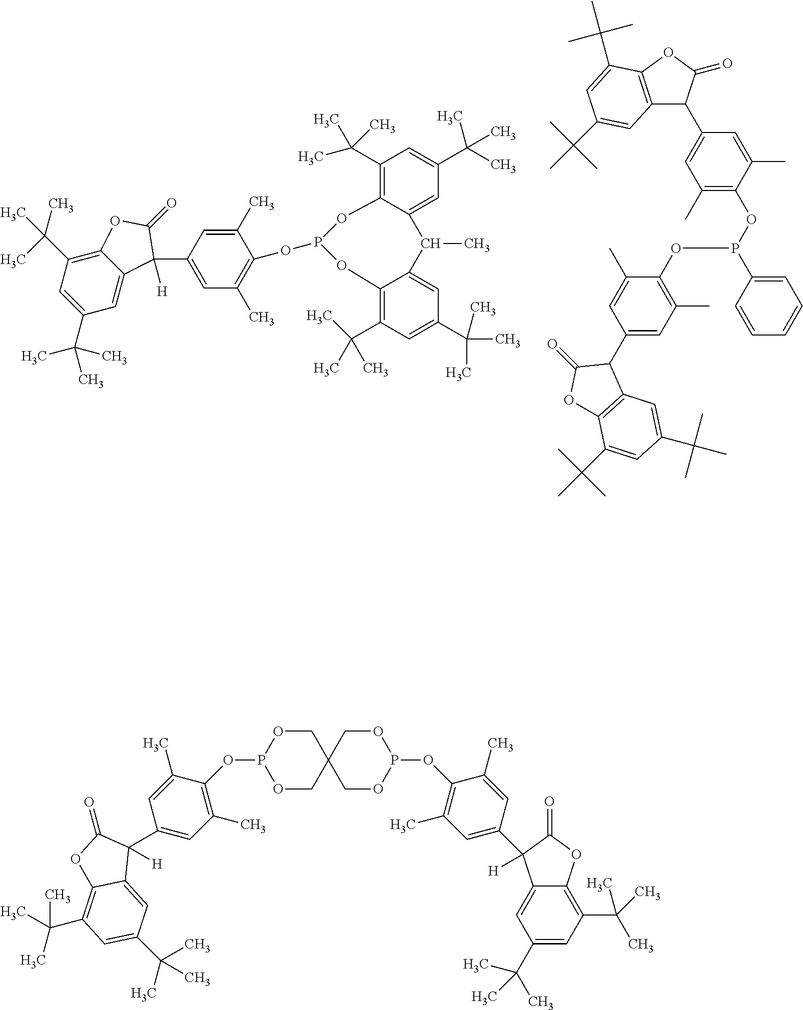
and e) and mixtures and combinations thereof.

31. The method according to claim 30, wherein the phenolic antioxidants are selected from the group consisting of the following compounds

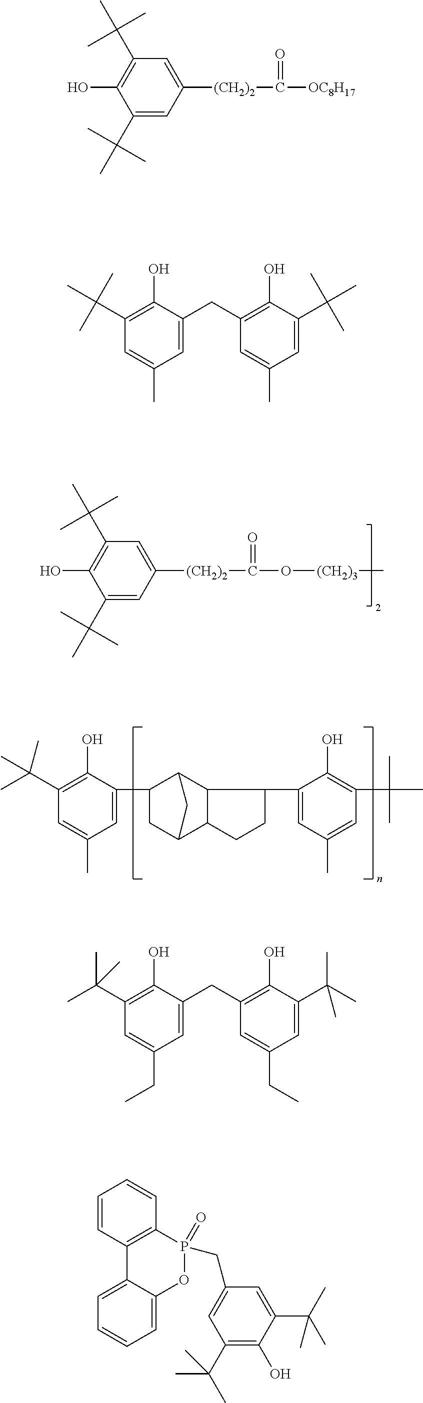

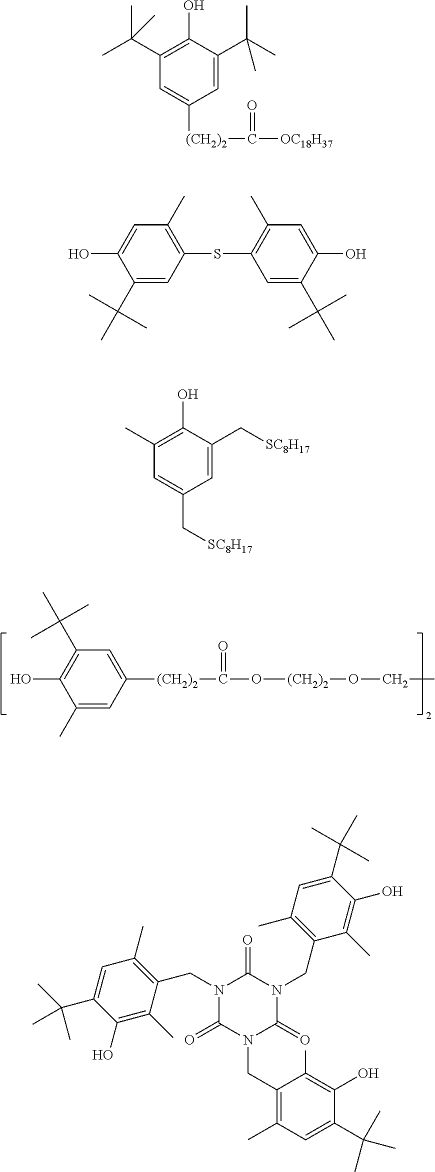

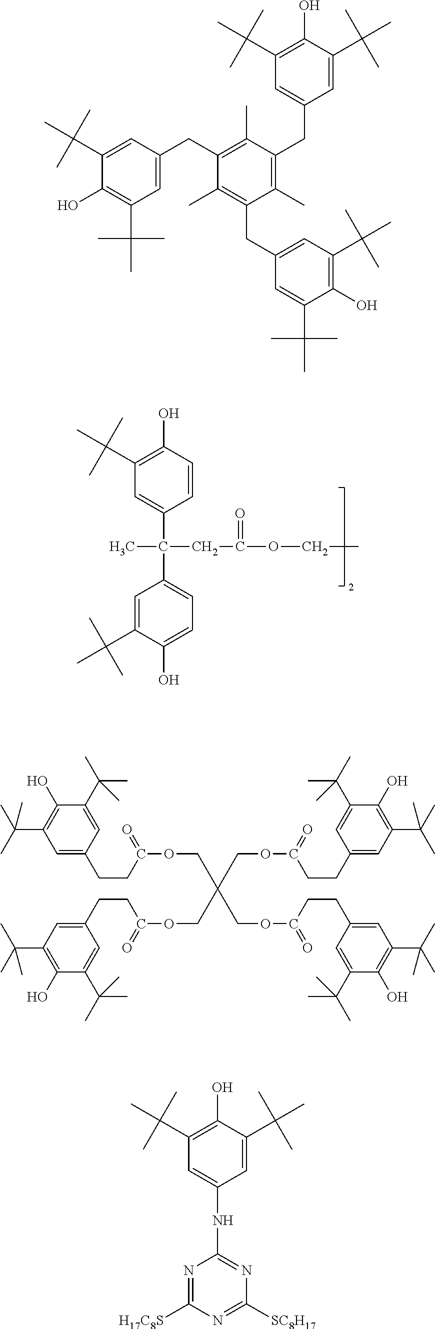

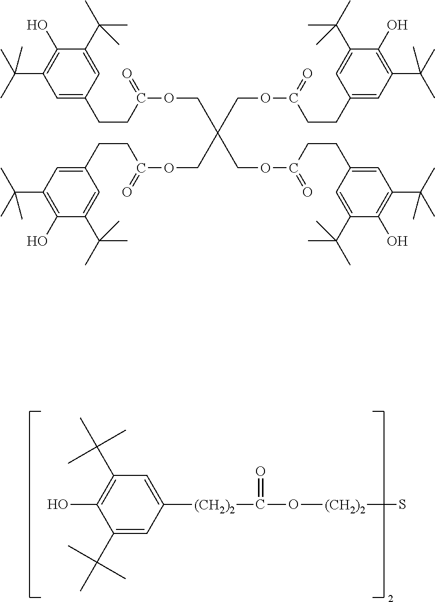

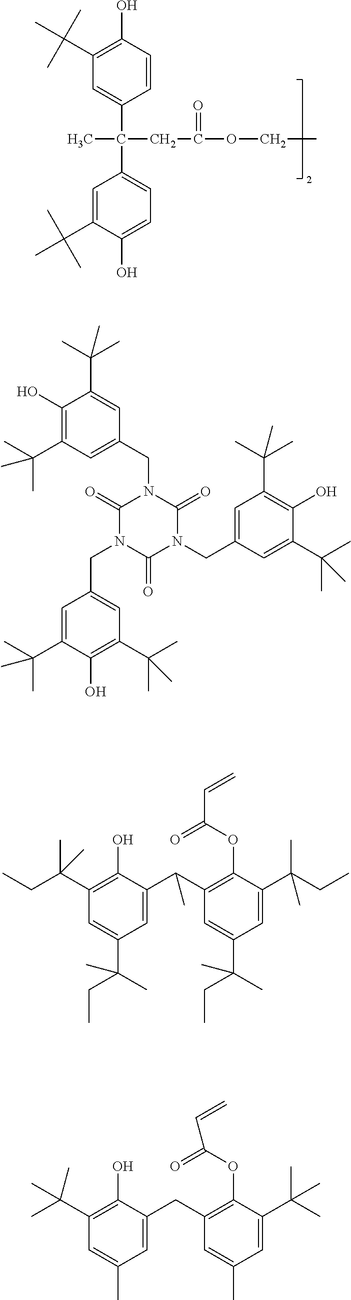

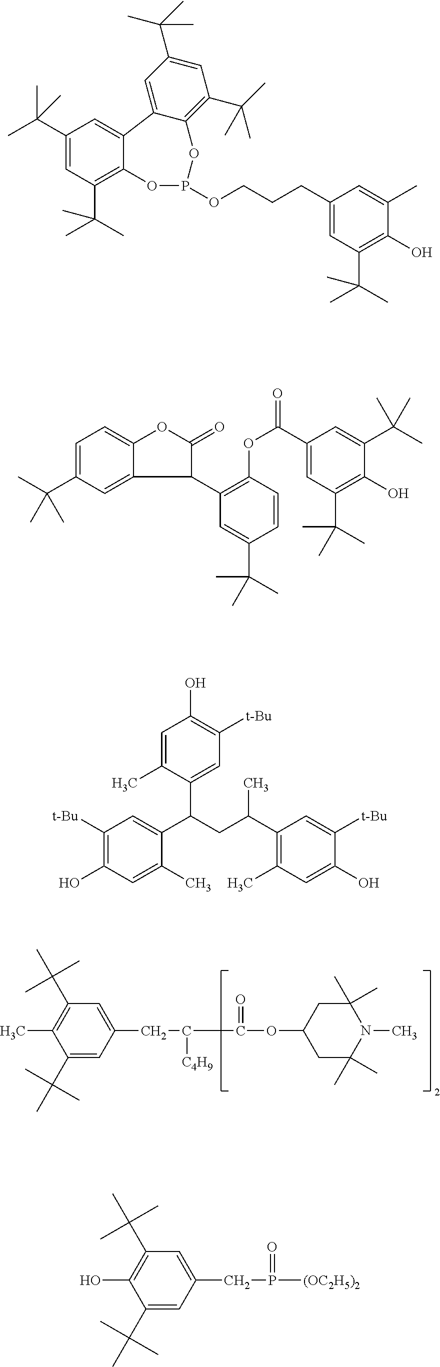

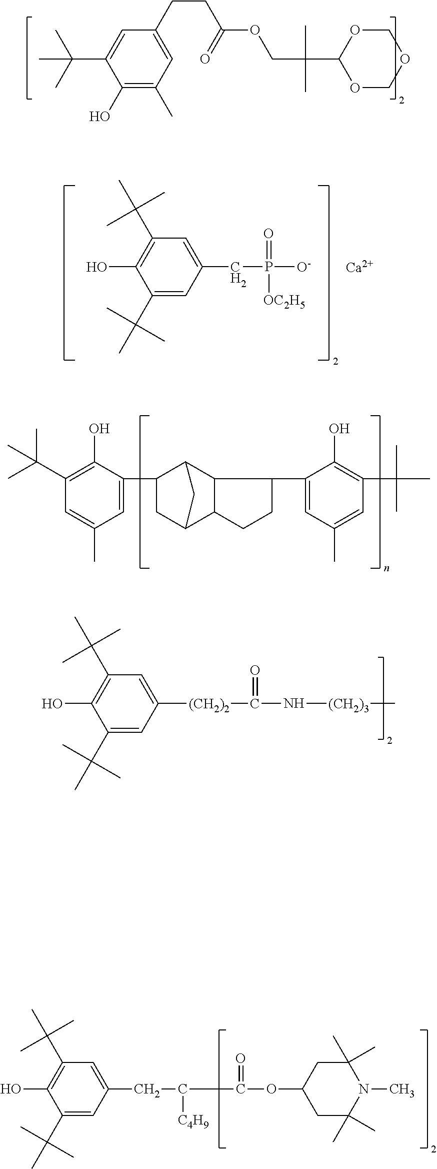

32. The method according to claim 30, wherein the aminic antioxidants are selected from the group consisting of the following compounds: 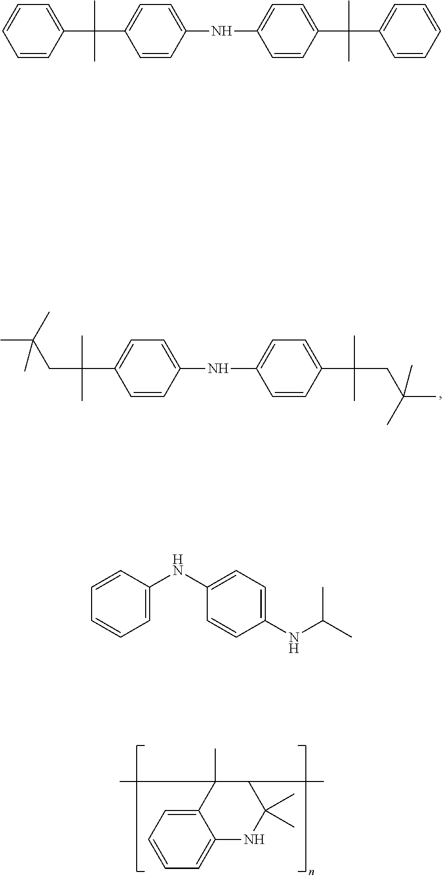
where n is from 2 to 100.

33. The method according to claim 23, wherein the stabilizer composition is combined with the thermoplastic recyclate in a weight ratio of 0.01 to 10.00 wt % with respect to the halogen-free thermoplastic plastic recyclate.

34. The method according to claim 23, wherein the totality of the at least one sulfite and/or of the at least one thiosulfate and the totality of the at least one primary antioxidant are present in a weight ratio of 1:99 to 99:1.

35. The method of claim 23, wherein the halogen-free thermoplastic plastic recyclate is selected from the group consisting of
a) recycled polymers of olefins or diolefins selected from the group consisting of LDPE, LLDPE, VLDPE, ULDPE, MDPE, HDPE, UHMWPE, metallocene PE (m-PE), polypropylene, polyisobutylene, poly-4-methyl-pentene-1, polybutadiene, polyisoprene, natural rubber (NR), polycyclooctene, polyalkylene-carbon monoxide copolymers, and copolymers in the form of statistical or block structures selected from the group consisting of polypropylene-polyethylene (EP), EPM or EPDM with 5-ethylidene-3-norbornene as a comonomer, ethylene-vinyl acetate (EVA), ethylene-acrylic ester selected from the group consisting of ethylene butyl acrylate, ethylene-acrylic acid and their salts (ionomers), and terpolymers selected from the group consisting of ethylene acrylic acid glycidyl(meth)acrylate, graft polymers selected from the group consisting of polypropylene graft maleic acid anhydride, polypropylene graft-acrylic acid, polyethylene graft acrylic acid, polyethylene polybutylacrylate graft maleic acid hydride, and blends of LDPE/LLDPE or also long chain branched polypropylene copolymers that are prepared with alpha olefins as comonomers wherein the comonomers are selected from the group consisting of 1-butene, 1-hexene, 1-octene, and 1-octadecene,
b) recycled polystyrene, polymethyl styrene, poly-alpha-methyl styrene, polyvinyl naphthalene, polyvinyl biphenyl, polyvinyl toluol, styrene butadiene (SB), styrene butadiene styrene (SBS), styrene ethylene butylene styrene (SEBS), styrene ethylene propylene styrene, styrene isoprene, styrene isoprene styrene (SIS), styrene butadiene acrylonitrile (ABS), styrene acrylonitrile (SAN), styrene acrylonitrile acrylate (ASA), styrene ethylene, styrene maleic acid anhydride polymers, incl. corresponding graft copolymers such as styrene on butadiene, maleic acid anhydride on SBS or SEBS, and graft copolymers of methylmethacrylte, styrene butadiene, ABS (MABS), and hydrogenated polystyrene derivatives or polyvinyl cyclohexane;
c) recycled polymers of unsaturated esters selected from polyacrylates and polymethacrylates, polymethyl methacrylate (PMMA), polybutyl acrylate, polyauryl acrylate, poly stearyl acrylate, polyglycidyl methacrylate, polyacrylonitrile, polyacrylamides, and polyacrylonitrile-polyalkylacrylate;
d) recycled polymers of unsaturated alcohols and derivatives selected from the group consisting of polyvinyl alcohol, polyvinyl acetate, polyvinyl butyral, poly allyl phthalate, and poly allyl melamine;
e) recycled polyacetates selected from the group consisting of polyoxymethylene (POM) and copolymers with butanal, polyphenylene oxides, and polyphenylene oxide blends with polystyrene or polyamides;
f) recycled polymers of cyclic ethers selected from the group consisting of polyethylene glycol, polypropylene glycol, polyethylene oxide, polypropylene oxide, polytetrahydrofuran;
g) recycled polyphenylene oxides and blends with polystyrene and/or polyamides;
h) recycled polyurethanes of hydroxy terminated polyethers or polyesters and aromatic or aliphatic isocyanates, and polyureas;
i) recycled polyamides selected from the group consisting of polyamide-6, 6.6, 6.10, 4.6, 4.10, 6.12, 10.10, 10.12, 12.12, polyamide 11, polyamide 12, partially or fully aromatic polyamides selected from the group consisting of polyphthalamides prepared from terephthalic acid and/or isophthalic acid and hexamethylene diamine or n-xylylene diamine, and those prepared from aliphatic dicarboxylic acids and aromatic diamines, blends of different polyamides,
j) recycled polyamides, polyamide imides, polyether imides, polyester imides, poly(ether)ketones, polysulfones, polyether sulfones, polyaryl sulfones, polyphenylene sulfides, polybenzimide azoles, or polyhydantoines,
k) recycled polyesters of aliphatic or aromatic dicarboxylic acids and diols or of hydroxy carboxylic acids selected from the group consisting of polyethylene terephthalate (PET), polybutylene terephthalate (PBT) polypropylene terephthalate (PTI), polyethylene naphthalate (PEN), poly-1,4-dimethylol cyclohexane terephthalate, polyhydroxy benzoate, polyhydroxy naphthalate, poly lactic acid (PLA), polyhydroxy butyrate (PHB), polyhydroxy valerate (PHV), polyethylene succinate, polytetramethylene succinate, and polycaprolactone,
l) recycled polycarbonates, polyester carbonates, and blends selected from the group consisting of PC/ABS, PC/PBT, PC/PET/PBT, and PC/PA,
m) recycled cellulose derivatives selected from the group consisting of cellulose nitrate, cellulose acetate, cellulose propionate, and cellulose butyrate, and
n) mixtures, combinations, or blends of two or more of the above-named polymers.

36. The method in accordance with claim 23, wherein the stabilizer composition is utilized in combination with at least one additive, wherein the at least one additive is selected from the group consisting of secondary antioxidants, UV absorbers, light stabilizers, metal deactivators, filler deactivators, antiozonants, nucleation agents, anti-nucleation agents, toughening agents, mold lubricants, rheological modifiers, thixotropic agents, chain extenders, processing aids, demolding aids, flame retardants, pigments, dyes, optical brighteners, antimicrobial active agents, antistatic agents, slip agents, anti-blocking agents, coupling agents, crosslinking agents, anti-cross-linking agents, hydrophilization agents, hydrophobing agents, bonding agents, dispersing agents, compatibilizers, oxygen captors, acid captors, expanding agents, degradation additives, defoaming agents, odor captors, marking agents, anti-fogging agents, fillers, reinforcement materials, and polyol costabilizers.

37. A stabilizer composition for stabilizing halogen-free thermoplastic plastic recyclates consisting of at least one sulfite and/or at least one thiosulfate in combination with at least one primary antioxidant.

38. The stabilizer composition in accordance with claim 37, wherein the totality of the at least one sulfite and/or thiosulfate and the totality of the at least one primary antioxidant are present in a weight ratio of 1:99 to 99:1.

39. A masterbatch or a concentrate comprising 10 to 90 wt % of a stabilizer composition in accordance with claim 37 and 90 to 10 wt % of a halogen-free thermoplastic resin or of a plastic recyclate.

40. A plastic composition comprising a stabilizer composition in accordance with claim 37 and a halogen-free thermoplastic plastic recyclate.

41. The plastic composition in accordance with claim 40, which comprises
(A) 0.01 to 10.00 wt. % of the stabilizer composition;
(B) 85.00 to 99.98 wt %, of the halogen-free thermoplastic plastic recyclate; and
(C) 0.01 to 5.00 wt % of at least one additive.

42. The composition according to claim 41, wherein the at least one additive is selected from the group consisting of secondary antioxidants excluding phosphites and phosphonites, UV absorbers, light stabilizers, metal deactivators, filler deactivators, antiozonants, nucleation agents, anti-nucleation agents, toughening agents, mold lubricants, rheological modifiers, thixotropic agents, chain extenders, processing aids, demolding aids, flame retardants, pigments, dyes, optical brighteners, antimicrobial active agents, antistatic agents, slip agents, anti-blocking agents, coupling agents, crosslinking agents, anti-cross-linking agents, hydrophilization agents, hydrophobing agents, bonding agents, dispersing agents, compatibilizers, oxygen scavengers, acid scavengers, expanding agents, degradation additives, defoaming agents, odor scavengers, marking agents, anti-fogging agents, fillers, reinforcement materials, and polyol costabilizers.

43. The composition according to claim 40, which comprises, with reference to 100 wt % of components (A to C), up to 80 wt % of at least one plasticizer, filler, and/or reinforcing material.

44. The composition according to claim 42, wherein the
i) acid scavengers are selected from the group consisting of salts of monovalent, bivalent, trivalent, and tetravalent metals;
ii) light stabilizers are selected from the group consisting of hindered amines; and/or
iii) fillers and/or reinforcement materials are selected from the group consisting of calcium carbonates, silicates, talcum, mica, kaolins, metal oxides, metal hydroxides, black carbon, graphite, wood flour, natural fibers, glass fibers, carbon fibers, polyamide fibers, other synthetic polymer fibers, hydrotalcites, zeolites, and phyllosilicates.

45. The composition according to claim 44, wherein the metals are selected from the group consisting of alkali metals, alkaline earth metals, aluminum or zinc and/or the salts are selected from fatty acid salts.

46. The composition according to claim 45, wherein the salts are selected from the group consisting of calcium stearate, magnesium stearate, zinc stearate, aluminum stearate, calcium laurate, calcium behenate, calcium lactate, and calcium stearoyl-2-lactate.

47. The composition according to claim 42, wherein the acid scavengers are selected from the group consisting of aluminum hydrotalcite, magnesium hydrotalcite and zinc hydrotalcite, hydrocalumites, zeolites, alkaline earth metals oxides, alkaline earth carbonates, dolomite, and alkaline earth hydroxides.

48. A molding compound or a molded part comprising a composition according to claim 40.

49. The molding compound or molded part according to claim 48, which is a film, packaging material, hollow body, part of an automobile, railroad, aircraft, ship, machine, or upholstery, construction section, construction film, roof sheeting, cable duct, siding, noise-insulating wall, drainage gutter, window section, door section, molded board, floor covering, pallet, road or agricultural construction application product, transport container, foam, tape, injection-molded part, fiber, extrudate, barrel, bucket, carrier bag, sack, pallet, or belt.

50. A method for oxidative, thermal, and/or actinic stabilization of a halogen-free thermoplastic plastic recyclate, the method comprising incorporation of at least one stabilization composition in accordance with claim 37 into the halogen-free thermoplastic plastic recyclate.

51. The method according to claim 50, wherein stabilization takes place during the thermal processing of the halogen-free thermoplastic plastic recyclate.

52. A method of preparing one or more of the following products comprising molding a composition according to claim 40, wherein the product is selected from the group consisting of a film, a packaging material, a hollow body, part of an automobile, railroad, aircraft, ship, or machine, part for a construction application, part for a road or agricultural application, transport container, automobile part, part for electrical or electronic industry, and part for agricultural application.
